(19) United States
(12) Patent Application Publication
(10) Pub. No.: US 2021/0326844 A1
(43) Pub. Date: Oct. 21, 2021

(54) BLOCKCHAINS FOR FACILITATING DECENTRALIZED FUND TRANSFER

(71) Applicant: MSHIFT, INC., Newark, CA (US)

(72) Inventors: Xiaomeng ZHOU, Hayward, CA (US); Scott MOELLER, Newark, CA (US); Jacqueline SNELL, Sacramento, CA (US); Andrew YEE, San Francisco, CA (US); David TCHEAU, Redwood City, CA (US); Alan FINKE, Pleasanton, CA (US); Robert OFFICER, Fremont, CA (US)

(21) Appl. No.: 17/111,792

(22) Filed: Dec. 4, 2020

Related U.S. Application Data
(63) Continuation of application No. PCT/US2019/038778, filed on Jun. 24, 2019.
(60) Provisional application No. 62/689,012, filed on Jun. 22, 2018.
(60) Provisional application No. 62/802,585, filed on Feb. 7, 2019.

(51) Int. Cl. G06Q 20/36; G06Q 20/06; G06Q 20/40; G06Q 20/38; G06Q 20/10

(52) U.S. Cl. CPC G06Q 20/363; G06Q 20/065; G06Q 2220/00; G06Q 20/389; G06Q 20/102; G06Q 20/4014

(57) ABSTRACT

Provided are systems and methods for facilitating fund transfer. The systems and methods described herein may facilitate fund transfer by utilizing blockchain networks, digitized financial credit (e.g., digital tokens), smart contracts, multiple clearing financial institutions, preference to push-only transfers (over pull-type transfers), and/or graphical codes, such as quick response (QR) codes.

### CROSS-REFERENCE

This application is a continuation of International Application No. PCT/US19/38778, filed Jun. 24, 2019, which claims the benefit of U.S. Provisional Patent Application No. 62/689,012, filed Jun. 22, 2018, and U.S. Provisional Patent Application No. 62/802,585, filed Feb. 7, 2019, each of which applications is entirely incorporated herein by reference.

### BACKGROUND

Funds can be transferred between different accounts, such as between different accounts within a financial institution (e.g., bank), between accounts at different financial institutions, between different accounts of one individual or entity, between accounts of different individuals or entities, and/or between accounts in financial institutions in different countries (or otherwise sovereign territories). A fund transfer may be made for any reason, for example, as a gift between two acquaintances, as a bill payment, as a payment for a purchase, as a settlement of a debt or other unsettled accounts, and other reasons. In some instances, funds can be transferred in the form of financial credit, such as tokens.

### SUMMARY

The transfers of funds can often involve non-insignificant costs, time delay, and security risk as the funds navigate the existing banking infrastructure, inconveniencing both senders and recipients of the funds. Therefore, recognized herein is a need for efficient, secure, and expedited fund transfer in the existing banking infrastructure. The systems and methods described herein may facilitate fund transfer by utilizing blockchain networks, digitized financial credit (e.g., digital tokens), smart contracts, multiple clearing financial institutions (FIs), preference to push-only transfers (over pull-type transfers), and/or graphical codes, such as quick response (QR) codes. The systems and methods may support any type of transfer, including, for example, an external funds transfer, person-to-person (P2P) transfer, business-to-business (B2B) transfer, purchase at a point of sale (POS), international remittance, online banking payment, government payment or disbursement, mortgage or bill payment, direct deposit or other type of fund transfer or payment. Embodiments of the systems and methods disclosed herein may implement any combination of the above methods. The systems and methods may be computer implemented. The systems and methods may include smartphones and mobile devices. The systems and methods may be implemented via, or with aid of, a distributed network of computer systems and/or cloud servers. The systems and methods may be an improved payment platform. Various aspects of the systems and methods described herein may be applied to facilitate fund transfers or any other financial services application.

In an aspect, provided is a method for facilitating payment, comprising: (a) receiving, at a server in communication with a blockchain network and a central entity, from a user device of a first user a selection of a method of payment to a second user; and (b) processing the payment, by the server, as follows: (i) if the method of payment is digital token, initiating a transfer of digital tokens from a digital account of the first user to a digital account of the central entity on the blockchain and (1) substantially simultaneously initiating a transfer of fiat currency in an equivalent amount to the digital tokens from a financial institution account of the central entity to a financial institution account of the second user, or (2) substantially simultaneously initiating a transfer of the same amount of the digital tokens from the financial institution account of the central entity to the financial institution account of the second user; (ii) if the method of payment is a hybrid between digital token and fiat currency, initiating a transfer of digital tokens from a digital account of the first user to a digital account of the central entity on the blockchain, initiating a transfer of fiat currency from a financial institution account of the first user to a financial institution of the second user, and substantially simultaneously initiating a transfer of fiat currency in an equivalent amount to the digital tokens from a financial institution account of the central entity to a financial institution account of the second user; and/or (iii) if the method of payment includes two types of digital token, including a reward token issued by the second user and a second digital token, initiating a transfer of the two types of digital tokens from digital accounts of the first user to digital accounts of the central entity on the blockchain, respectively, burning the reward token issued by the second user, and substantially simultaneously initiating a transfer of an amount of the second digital token from a financial institution account of the central entity to a financial institution account of the second user.

In some embodiments, the central entity has received verification of an identity of the first user and an identity of the second user.

In some embodiments, the method further comprises, prior to (a), initiating a fund transfer from the first user using the user device.

In some embodiments, the initiating comprises using a graphical code. In some embodiments, the graphical code comprises a quick response (QR) code.

In some embodiments, the initiating is performed on a web-based interface.

In some embodiments, the initiating is performed on a mobile-based interface.

In another aspect, provided is a system for a digital token economy utilizing a plurality of blockchain networks, comprising: a first blockchain network hosting a first digital token; a second blockchain network hosting a second digital token; and one or more servers associated with a central entity in operative communication with the first blockchain network and the second blockchain network, wherein the central entity comprises a plurality of registered users, and wherein the one or more servers are configured to transfer an amount of the second digital token to a registered user of the plurality of registered users for an activity or transaction conducted by the registered user on the first blockchain network using the first digital token.

In another aspect, provide is a system for a digital token economy utilizing a plurality of blockchain networks, comprising: a first blockchain network hosting a first digital token; a second blockchain network hosting a second digital token and a third token; and one or more servers associated with a central entity in operative communication with the first blockchain network and the second blockchain network, wherein the central entity comprises a plurality of registered users, including a first user and a second user, and wherein the one or more servers are configured to perform or facilitate one or more actions selected from: (i) transferring a first amount of the second digital token to a user holding the first digital token based on an interest rate of the first digital token, wherein the interest rate is within a first range; (ii) transferring a second amount of the second digital token to a user holding the second digital token based on an interest rate of the second digital token, wherein the interest rate is within a second range; (iii) adjusting or maintaining a reserve ratio requirement for the second token, wherein the third token is issued by the second user based on the reserve ratio requirement of the second token, wherein the reserve ratio requirement is within a third range of a total value of the third token issued; (iv) adjusting or maintaining an inflation of the second digital token between about 2% to about 6% by (1) adjusting the reserve ratio requirement within the third range or (2) adjusting the interest rate of the first digital token by selling and/or buying the first token; (v) selling or buying the second digital token with the first digital token or other cryptocurrencies or fiat currencies; and (vi) increasing or reducing the interest rate of the second digital token.

In some embodiments, the first range is between 0% to 20%.

In some embodiments, the second range is between 0% to 20%.

In some embodiments, the third range is between 0% to 20%.

In some embodiments, a transaction fee associated with payment from the first user to the second user paid in the second token or third token is zero.

In some embodiments, the third token issued by the second user is only redeemable with the second user.

In some embodiments, the third token is issued by the second user to the first user free of charge via airdrop.

In some embodiments, the second user is capable of receiving the first digital token, by direct or indirect transfer, in the second blockchain network, from a first digital account of the first user to a second digital account of the second without passing through the one or more servers associated with the central entity, if both users are verified by authoritative entities which provide digital accounts of the second blockchain network to the first user and the second user.

In another aspect, provided is a system for facilitating payment, comprising: a server in communication with a blockchain network and a central entity, wherein the server comprises one or more processors, individually or collectively, configured to: receive, from a first user device of a first user, a selection of a method of payment to a second user; and process the payment as follows: (i) if the method of payment is digital token, initiating a transfer of digital tokens from a digital account of the first user to a digital account of the central entity on the blockchain and (1) substantially simultaneously initiating a transfer of fiat currency in an equivalent amount to the digital tokens from a financial institution account of the central entity to a financial institution account of the second user, or (2) substantially simultaneously initiating a transfer of the same amount of the digital tokens from the financial institution account of the central entity to the financial institution account of the second user; (ii) if the method of payment is a hybrid between digital token and fiat currency, initiating a transfer of digital tokens from a digital account of the first user to a digital account of the central entity on the blockchain, initiating a transfer of fiat currency from a financial institution account of the first user to a financial institution of the second user, and substantially simultaneously initiating a transfer of fiat currency in an equivalent amount to the digital tokens from a financial institution account of the central entity to a financial institution account of the second user; and/or (iii) if the method of payment includes two types of digital token, including a reward token issued by the second user and a second digital token, initiating a transfer of the two types of digital tokens from digital accounts of the first user to digital accounts of the central entity on the blockchain, respectively, burning the reward token issued by the second user, and substantially simultaneously initiating a transfer of an amount of the second digital token from a financial institution account of the central entity to a financial institution account of the second user.

In some embodiments, the central entity has received verification of an identity of the first user and an identity of the second user.

In some embodiments, the one or more processors are, individually or collectively, further configured to, receive a fund transfer initiation from the first user to the second user.

In some embodiments, the initiation comprises use of a graphical code. In some embodiments, the graphical code comprises a quick response (QR) code.

In some embodiments, the one or more processors are, individually or collectively, further configured to, provide a web-based interface for the fund transfer initiation to the user device.

In some embodiments, the one or more processors are, individually or collectively, further configured to, provide a mobile-based interface for the fund transfer initiation to the user device.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 shows a schematic illustration of a fund transfer system in communication with a blockchain network.

FIG. 2 illustrates an example of a transaction flow with a blockchain network involving fiat currency and digital token exchange.

FIG. 3 shows a process flow for facilitating payment using graphical codes.

FIG. 4A shows a schematic transfer flow from a central entity account to a merchant account with an intermediary clearing account and a corresponding timeline of the transfer flow.

FIG. 4B shows a schematic transfer flow from a central entity account to a merchant account with an intermediary clearing account and intermediary holding accounts and a corresponding timeline of the transfer flow.

FIG. 5 illustrates another example of a transaction flow with a blockchain network involving fiat currency and digital token exchange.

FIG. 6 illustrates transaction flows with a blockchain network and multiple clearing financial institutions.

FIG. 7 shows a schematic transfer flow with multiple intermediary clearing accounts at multiple intermediary clearing financial institutions.

FIG. 8 illustrates an example process for initiating a fund transfer.

FIG. 9 illustrates a flow chart of different digital tokens.

FIG. 10 illustrates the network architecture of a plurality of digital tokens.

FIG. 11 illustrates an example of a process flow for rewarding a user with digital tokens along with a receipt.

FIG. 12 illustrates an example of a process flow for rewarding a user with digital tokens for an electronic commerce payment.

FIG. 13 illustrates another example of a process flow for rewarding a user with digital tokens.

FIG. 14 illustrates another example of a transaction flow with a blockchain network involving fiat currency and digital token exchange, involving reimbursements.

FIG. 15 illustrates a dual blockchain token economy structure.

FIG. 16 shows computer control systems that are programmed to implement systems and methods of the disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Fund transfers can often involve significant costs and/or time delay, individually or in the aggregate, that can inconvenience both senders and recipients of the funds. Often these costs and/or time delay can vary with the type of transfer, such as within or between financial institutions. A financial institution (FI) can be a deposit-taking institution, such as a bank, building society, credit union, trust company, brokerage, mortgage loan company, or other loan companies. A financial institution can be an insurance company, trust company, pension fund, broker, underwriter, investment fund, or other institutions or entities dealing with financial transactions. In some instances, a financial institution may be an exchange or trade, such as a stock exchange, securities exchange, or cryptocurrency exchange. Any description herein of a bank may apply to any other type of financial institution. A financial institution can allow a user to have or manipulate (e.g., buy, sell, trade, exchange, etc.) financial property, such as an account or a trust, with or entrusted to the financial institution. Such accounts or trusts can contain money, funds, or other tangible or intangible objects of positive (e.g., credit) or negative (e.g., debit, loans, etc.) financial value. An account can be a demand deposit account (DDA), checking account, savings account, line of credit account, loan account or other type of account. An accountholder at a bank can have a plurality of the same or different accounts at the bank. A plurality of accountholders can share a single account.

For example, funds can be transferred between different accounts within a same bank, between accounts at different banks, between different accounts of one individual or entity, between accounts of different individuals or entities, and/or between accounts in banks in different countries (or otherwise sovereign territories). In some instances, a transfer of funds between accounts within a same bank may be completed as an “on us” transaction, without cost or with lower cost to the sender and the recipient. Other types of transfers may incur various costs, such as by a bank of the sender, bank of the recipient, and/or intermediary system (e.g., clearing bank) facilitating the transfer. For example, for a credit card purchase, a discount rate and a transaction fee can be collected by the credit card company to process the fund transfer. Such discount rate and/or transaction fee can be a flat fee or a certain percentage of the amount of transfer (e.g., volume). Transaction fees can include fees such as authorization fees, return fees, gateway fees, AVS fees, currency exchange fees, and other fees charged to a transferor or transferee of funds. In another example, for an external fund transfer or interbanking fund transfer, there may be transactional fees associated with using an interbanking network such as the Automated Clearing House (ACH). Different types of transfers can be completed in different durations of time. For example, an “on us” transaction can be completed in a relatively shorter amount of time than other forms of transfer. An “on us” transfer can be instantaneous or substantially instantaneous. Instantaneous can include a response time of less than 10 seconds, 9 seconds, 8 seconds, 7 seconds, 6 seconds, 5 seconds, 4 seconds, 3 seconds, 2 seconds, 1 second, tenths of a second, hundredths of a second, a millisecond, or less. In some instances, an “on us” transfer can be completed in at most one business day.

The systems and methods described herein may facilitate fund transfer by utilizing blockchain networks, digitized financial credit, smart contracts, multiple clearing financial institutions (FIs), preference to push-only transfers (over pull-type transfers), and/or graphical codes, such as quick response (QR) codes. The systems and methods may support any type of transfer, including, for example, an external funds transfer, person-to-person (P2P) transfer, business-to-business (B2B) transfer, purchase at a point of sale (POS), international remittance, online banking payment, government payment or disbursement, mortgage or bill payment, direct deposit or other type of fund transfer or payment.

Reference is now made to the figures.

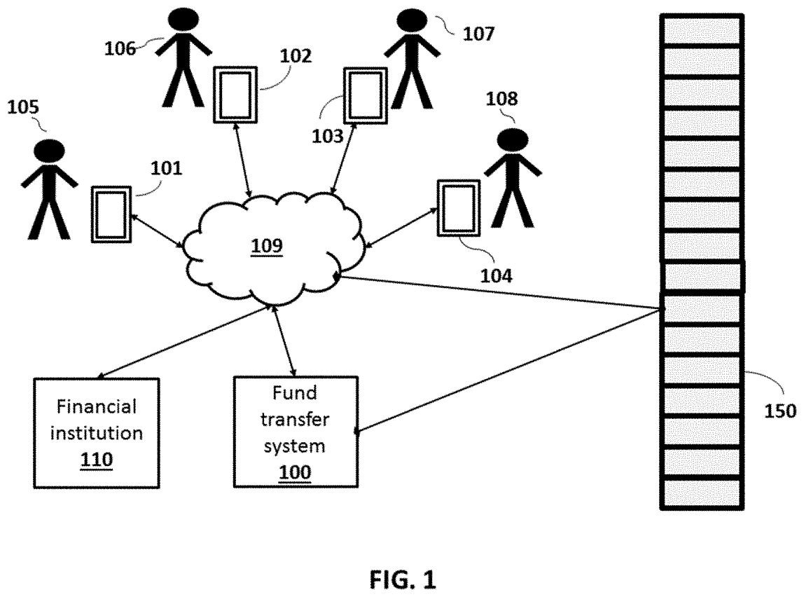

FIG. 1 shows a schematic illustration of a fund transfer system in communication with a blockchain network. A fund transfer system 100, comprising and/or in communication with a blockchain network 150, may communicate with a plurality of users. For example, users 105, 106, 107, and 108 may communicate with the system 100 via user devices 101, 102, 103, and 104, respectively. A user (e.g., users 105, 106, 107, and 108) can be an individual or entity that is capable of engaging with the system 100. For example, a first user 105 may communicate with the system 100 via a first user device 101, a second user 106 may communicate via a second user device 102, a third user 107 may communicate via a third user device 103, and an nth user 108 may communicate with the system 100 via an nth user device 104. The system 100 may communicate simultaneously and/or independently with a plurality of users. In some instances, the system 100 may communicate with only a certain number of users (e.g., no more than 1, 2, 3, 4, 5, 6, 7, 8, 9, 10, 20, 30, 40, 50, 100, 150, 200, 250, 300, 400, 500, 1000, 10,000, 100,000, etc.) at certain times. Each of the users may communicate with the system 100 via a network 109.

A user can be a consumer, a merchant, a transferor, a transferee, a sender, a recipient, and/or any party to a fund transfer or other financial transaction. A user can be an individual or entity capable of legally owning financial property, such as an account, with financial institutions. A user can be an individual or entity capable of owning property, such as money. A user can be an individual or entity capable of depositing, withdrawing, entrusting, and/or storing, such property with financial institutions. For example, a user can be a legal entity (e.g., corporation, partnership, company, LLC, LLLC, etc.). A user can be a government or government entity. A user can be an individual or entity capable of initiating, sending, receiving, and/or approving a financial transfer or financial transaction.

The network 109 may be configured to provide communication between various components of the network layout depicted in FIG. 1. The network 109 may comprise one or more networks that connect devices and/or components in the network layout to allow communication between the devices and/or components. For example, the network may be implemented as the Internet, intranet, extranet, a wireless network, a wired network, a local area network (LAN), a Wide Area Network (WANs), Bluetooth, Near Field Communication (NFC), or any other type of network that provides communications between one or more components of the network layout. In some embodiments, the network 109 may be implemented using cell and/or pager networks, satellite, licensed radio, or a combination of licensed and unlicensed radio. The network may be wireless, wired (e.g., Ethernet), or a combination thereof. Systems and devices communicating the network 109 may communicate with the network via one or more network adaptors and/or communication interfaces. Additionally, while the network 109 is shown in FIG. 1 as a “central” point for communications between various components (e.g., fund transfer system 100, financial institution 110, user devices 101, 102, 103, and 104) of the network layout, the disclosed embodiments are not limited thereto. For example, one or more components of the network layout may be interconnected in a variety of ways, and may in some embodiments be directly connected to, co-located with, or remote from one another, as one of ordinary skill will appreciate. The network 109 can span across state or sovereign boundaries, such that the system 100 located in a first sovereign state can communicate with a user 105 located in a second sovereign state. A user 105 located in the second sovereign state can communicate with a user 106 located in a third sovereign state.

The user devices 101, 102, 103, and 104 may be an electronic device. For example, the user devices 101-104 may each be a mobile device (e.g., smartphone, tablet, pager, personal digital assistant (PDA)), a computer (e.g., laptop computer, desktop computer, server), and/or a wearable device (e.g., smartwatches). A user device can also include any other media content player, for example, a set-top box, a television set, a video game system, or any electronic device capable of providing or rendering data. For example, a user device can be a credit card processing machine or card reader. The user device may optionally be portable. The user device may be handheld. The user device may be a network device capable of connecting to a network, such as the network 109, or other networks such as a local area network (LAN), wide area network (WAN) such as the Internet, intranet, extranet, a telecommunications network, a data network, and/or any other type of network.

A user device may each comprise memory storage units which may comprise non-transitory computer readable medium comprising code, logic, or instructions for performing one or more steps. A user device may comprise one or more processors capable of executing one or more steps, for instance in accordance with the non-transitory computer readable media. The user device may comprise a display showing a graphical user interface (GUI). The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. For example, a user may input financial transaction commands or instructions to the system 100 via one or more user interactive devices. The user device may be capable of communicating with or executing software or applications provided by one or more systems (e.g., financial institution 110, fund transfer system 100, etc.). One or more applications may be related to fund transfer, payment processing, or financial transactions. One or more applications and/or software can be related to a payment processing platform or fund transfer platform. One or more applications and/or software may be implemented in conjunction with a user interface on a GUI. For example, the user interface can be a mobile-based interface and/or a web-based interface.

A user device may comprise one or more sensors. For example, a user device may comprise one or more geo-location sensors that may be useful for detecting the location of the user device. For example, the geo-location sensors may use triangulation methods or global positioning systems (GPS) to aid in determining a location of the computing device. For example, one or more cell towers can use triangulation methods to locate a user device emitting or transmitting signals. A user device may comprise an image capture device or other optical sensor (e.g., camera) and be capable of capturing an image and/or reading an image (e.g., a code, text, etc.). For example, a camera can be integrated in the user device. The camera can be an external device to the user device and communicate via wired (e.g., cable) or wireless (e.g., Bluetooth, Wi-Fi, NFC, etc.) connection. The image capture device may be useful for capturing an image of the user or any other object within the user's environment. In some instances, the user device may receive or access one or more images captured by an external device in the external device memory, user device memory, and/or a separate storage space, including a database of a server or a cloud storage space. A user device may comprise a beacon (e.g., Bluetooth beacon) that is configured to broadcast an identifier or other data to nearby electronic devices. A user device may comprise an electronic display capable of displaying a graphical user interface. The user device may include biometric sensors such as fingerprint readers or retina scanners.

The user device may be, for example, one or more computing devices configured to perform one or more operations consistent with the disclosed embodiments. In some instances, the software and/or applications may allow the users 105, 106, 107, and 108 to register with the fund transfer system 100, register with the financial institution 110, transmit and/or receive requests, commands, or instructions relating to financial transactions (e.g., fund transfer, payment processing, etc.), detect a location of the user device, broadcast an identifier or other data, transmit, receive, and/or process data, capture an image, read an image, such as read text via one or more optical character recognition (OCR) algorithms or read a code via one or more decrypting or decoding algorithms, and/or display an image.

The fund transfer system 100 may communicate with one or more users (e.g., users 105, 106, 107, and 108) via the network 109 to coordinate a plurality of transactions from, to, and/or between the one or more users and the system 100. In some instances, the system 100 may be configured to reliably identify an individual and authenticate the identified individual before accepting a user command or instruction (e.g., payment processing instruction, fund transfer instruction). To accomplish this, the system 100 may be programmed with (or otherwise store in memory instructions to implement) software and/or application to authenticate a user by requesting user credentials (e.g., PIN, passcode, password, username, cryptographic proof, etc.) and verifying identification. In some instances, the system 100 may be in communication with hardware, for example, a biometric reader, for distinguishing the identity of the authorized user from an impostor. The biometric reader may require an enrollment step, methods and hardware for acquiring the biometric data, and methods for comparing the biometric data that is acquired with the biometric data that the user enrolled with. A biometric reader used in this capacity may have thresholds for determining whether a biometric reading falls within the acceptable confidence range of the enrolled content. In some instances a biometric reader of this type may have built-in controls that prevent the biometric reader from being tampered with, should an impostor wish to use unintended means for accessing or authorizing sharing of the content. In some instances, the system 100 may communicate with an external device comprising the biometric reader. For example, user devices 101, 102, 103, and 104 can comprise biometric readers (e.g., sensors for fingerprints, retina, audio, facial recognition etc.) communicating with the system 100.

The system 100 and/or user devices of the users can individually or collectively comprise a biometric module for collecting, storing, processing, translating or analyzing biometric data. Biometric data may include any feature or output of an organism that can be measured and used to uniquely identify the organism. Biometric data may include, but are not be limited to, fingerprints, DNA, body temperature, facial features, hand features, retina features, ear features, and behavioral characteristics such as typing rhythm, gait, gestures and voice. The biometric module may receive data from biometric readers, for example, a fingerprint reader or retinal scanner, optical sensors, microprocessors, and RAM/ROM memory. Software components of the biometric module may comprise one or more software-based programs, including applications, protocols, or plugins, configured for collecting and/or processing biometric data from the hardware components of the biometric module. In some instances, collection and processing biometric data may comprise operations for analyzing the biometric data, creating a template (i.e. digital template) for biometric data, storing, matching, and verifying the biometric data (i.e. with an external database or previously stored information). In some embodiments a biometric reader may also be coupled to a user device through wired or wireless approaches. Wireless approaches may include one or more types of Wi-Fi or peer-to-peer (P2P) networking protocols. In other embodiments a biometric reader may be built into the web-enabled device. In some embodiments, the biometric module may be included, installed, or attached to the user device.

A fund transfer system 100 may render information so that a user can identify and be presented with one or more content relating to a financial transaction (e.g., fund transfer, payment processing, etc.), such as on a payment processing platform. The system 100 may be further configured to process one or more images (e.g., QR codes, etc.) for display. The images that are processed may include images of payment instruments, such as checks. The system 100 may be communicatively coupled to another device (e.g., user devices 101, 102, 103, 104) comprising a screen, specialized display, and/or graphical user interface.

The system 100 may comprise one or more servers to perform some or all operations of the system 100, as described herein. A server, as the term is used herein, may refer generally to a multi-user computer that provides a service (e.g. validation, etc.) or resources (e.g. file space) over a network connection. The server may be provided or administered by an online service provider or administrator. In some cases, the server may be provided or administered by a third party entity in connection with a device provider. Any description of a server herein can apply to multiple servers or other infrastructures. For example, one or more servers can collectively or individually perform the operations of the system 100 disclosed herein. In some instances, the server may include a web server, an enterprise server, a database server, or any other type of computer server, and can be computer-programmed to accept requests (e.g., HTTP, or other protocols that can initiate data transmission) from a computing device (e.g., a user device, a public share device) and to serve the computing device with requested data. In addition, the server can be a broadcasting facility, such as free-to-air, cable, satellite, and other broadcasting facility, for distributing data. The server may also be a server in a data network (e.g., a cloud computing network, peer-to-peer configuration, etc.).

In some embodiments, the online service provider of the system 100 may administer one or more servers to provide various services to users of the system. While some disclosed embodiments may be implemented on the server, the disclosed embodiments are not so limited. For instance, in some embodiments, other devices (such as one or more user devices of the users) or systems (such as one or more financial institutions) may be configured to perform one or more of the processes and functionalities consistent with the disclosed embodiments, including embodiments described with respect to the server.

The fund transfer system 100 may comprise and/or be in communication with one or more databases, such as the blockchain network 150. The blockchain network may be a distributed ledger enabling the storage of data records as unique blocks connected by one or more secure links. The blockchain network may be cryptographically secured. A given block in a blockchain network may associate transaction data with a timestamp. In the blockchain network, duplicate data can be recorded as unique blocks instead of as identical copies of data. A given block may comprise data of a previous block to the given block (e.g., wherein the data of the previous block is hashed), making the blockchain network essentially immutable, as data once recorded in a block in the distributed ledger cannot be modified or removed without triggering inconsistency with the linked blocks. This immutable property can provide particular benefits to recording financial transactions or otherwise processing financial transactions, such as to prevent forgery or other frauds in processing digital credits. The blockchain network may comprise one or more smart contracts, as described elsewhere herein.

The blockchain network 150 may be stored in one or more nodes. The one or more nodes may be distributed in one or more computer systems or devices, such as those described herein (e.g., 101, 102, 103, 104, 100, 110, etc.). When the blockchain network is updated, such as by one of the nodes in the one or more nodes, it may be updated in each node of the one or more nodes, such as via the network 109. The blockchain may be publicly accessed by any node providing benefits of verifiability and auditability without restricting access.

In some instances, decentralized operating systems, such as EOS, may be used to develop distributed applications on the decentralized operating system platform. In some instances, a distributed application in a first blockchain may be capable of communicating with a distributed application in a second blockchain (and other blockchain), and be capable of sharing frameworks, and/or libraries. A blockchain of the present disclosure may be capable of parallel processing of a plurality of transactions, such as to allow for processing of on the order of 10, 100, 1000, 10,000 or more transactions per second. A blockchain of the present disclosure may be capable of operating a delegated proof of stake system (e.g., differentiated from proof of work which can be resource-intensive or proof of stake) by running one or more consensus algorithms. A blockchain of the present disclosure may be capable of operating any other proof system. The systems and methods herein may provide two or more blockchain networks working in conjunction, such as to provide a dual blockchain architecture, a triple blockchain architecture, or higher degrees of blockchain architecture. In some instances, there may be one or more main blockchains and/or one or more sisterchains (also referred to herein as sister blockchain) to the main blockchain. A sisterchain may allow for use of a custom native token, such as for optimized resource allocation.

A user (e.g., user 105, 106, 107, or 108) may be registered to the system 100, such as via creating an online account with a server of the system 100. Upon registration, the user may provide the system 100 with information that enables a system to process a transaction to or from the user. For example, the user may provide personal financial information, such as name of a financial institution, account number, and routing information. In some instances, only registered users may be provided with one or more services of the fund transfer system 100. In other instances, any user, registered or not, may be provided with one or more services of the fund transfer system 100. For example, a registered user can be capable of receiving funds. The system 100 may directly deposit funds received from a sender into the registered user's account using information provided by the registered user. The registered user may be provided with other services or options upon receipt of a fund transfer, such as the ability to re-transfer, gift, exchange the funds for another form of funds, or split tender. An unregistered user can be capable of receiving funds. For example, upon receipt of the fund transfer, the system 100 can prompt the unregistered user to register with the system 100 to open up other capabilities provided to registered users (e.g., re-transfer, gift, split tender, direct deposit to FI account, etc.). An unregistered user may be tendered the received funds, such as through an identifier (e.g., barcode, graphical code, code, PIN, etc.) which can be provided by the unregistered user to an automated teller machine (ATM) of a FI or a register user (e.g., sender, third party) of the system 100. A registered user may be able to transfer funds to a registered recipient or an unregistered recipient. For example, the system 100 may use information provided by the registered user (e.g., account information, etc.) to initiate the transfer. Such transfers facilitated by the system 100 can be “push” type transfers. “Push” and “pull” transfers are described further below.

Beneficially, since the system 100 can act as an intermediary in all transactions, the recipient never receives sensitive information, such as a credit card number or FI account number, from or associated with the sender that can be used or reused for fraudulent or other malicious purposes, thus reducing fraud that may occur in other payment systems. For example, recipients of payments, goods, services, P2P transfers, B2B transfers, and other transfers do not receive sensitive and/or personal information from their respective senders. Similarly, and beneficially, the sender never receives sensitive information from or associated with the recipient thus enhancing the security of the invention. Such sensitive and/or personal information is shared with the system 100, and within the system network, thus protecting against potential leak of, or compromise to, the data outside the unsecure system network. The fund transfer system 100, Sender FIs or recipient FIs may retain information of the other, such as for compliance with regulations, but protect such information from the accountholders.

In some instances, the fund transfer system 100 can be used in conjunction with a financial institution 110, and/or one or more systems operated thereby. The financial institution 110 can communicate with the fund transfer system 100 via the network 109. The financial institution 110 can communicate with one or more user devices (e.g., user devices 101, 102, 103, and 104) via the network 109 or another network. In some instances, a user (e.g., user 105, 106, 107, or 108) may be registered to or enrolled with the financial institution 110. For example, a user may or may not have an account with the financial institution 110. In some instances, a user may be registered to both the fund transfer system 100 and the financial institution 110. In such cases, the user may authorize the fund transfer system 100 and the financial institution 110 to share user information (e.g., user account information, user account history, user transaction information, personal financial information such as account number and routing number, etc.). While only one financial institution 110 is shown in FIG. 1, there may be multiple different financial institutions 110 communicating with the network 109.

In some instances, the fund transfer system 100 can be used in conjunction with any other systems and/or servers (e.g., hosting a site, website, forum, blog, etc.) through which a user can initiate or become party to a financial transaction. The fund transfer system 100 can be used with a plurality of other systems and/or servers. For example, the fund transfer system 100 can communicate with one or more financial network systems (e.g., automated clearing house (ACH) network, SWIFT network, etc.). In another example, the fund transfer system 100 can communicate with or be integrated in an independent system (e.g., web-based interface) hosted by a merchant. The transfers described herein can be implemented and/or initiated, individually or collectively, by the one or more systems described herein. For example, an application and/or software deployed or administered by one system (e.g., fund transfer system 100, financial institution 110) can be integrated or incorporated into an application and/or software deployed or administered by another system and/or into hardware devices (e.g., user devices). The application and/or software can be deployed or administered by an intermediary entity (e.g., not the financial institution 110, not a party to the transfer such as the merchant or the customer, etc.). Alternatively or in addition, an application and/or software can be provided as a standalone application. Alternatively or in addition, an application and/or software can be integrated or incorporated into other applications or hardware devices.

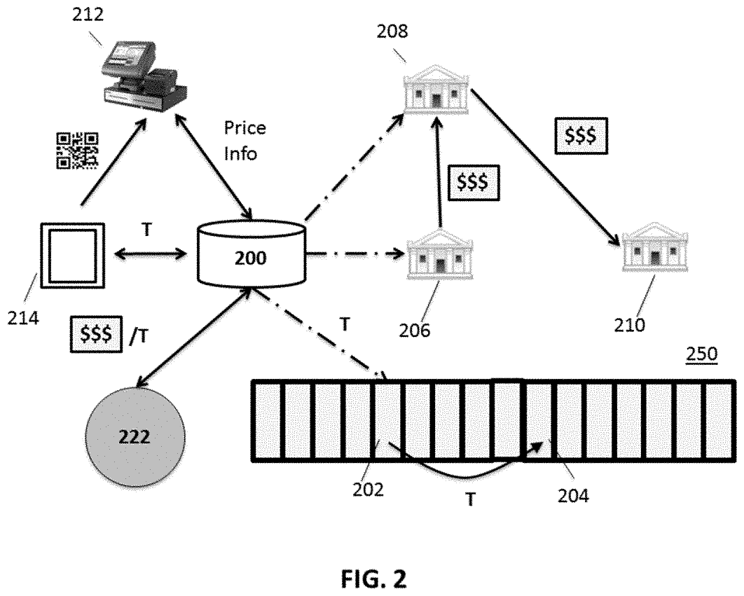

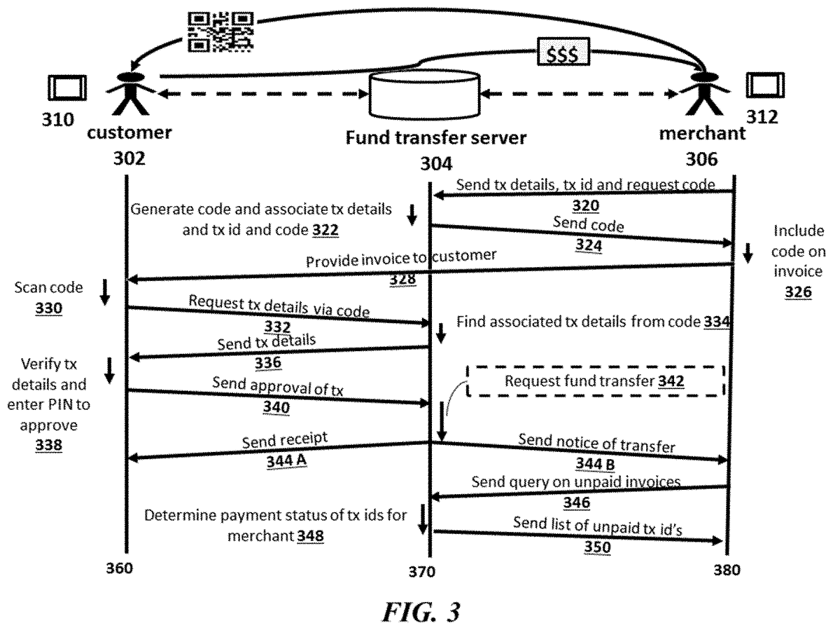

FIG. 2 illustrates a transaction flow with a blockchain network involving fiat currency and digital token exchange. A first user (e.g., consumer) may use user device 214 and a second user (e.g., merchant) may use user device 212 to initiate a fund transfer between the first user and the second user, such as via using graphical codes (e.g., quick response (QR) codes) or NFC devices and communicating with the fund transfer system 200. The fund transfer system 200 can comprise and/or be in communication with blockchain network 250. In some instances, the user devices 212, 214 may correspond to user devices 101, 102, 103, 104 in FIG. 1, the fund transfer system 200 may correspond to the fund transfer system 100 in FIG. 1, and the blockchain network 250 may correspond to the blockchain network 150 in FIG. 1. The communication between the user device 214, user device 212, and the fund transfer system 200, including graphical codes, is illustrated further in FIG. 3. While FIG. 3 illustrates invoice payment between a customer and a merchant, the payments are not limited as such. The descriptions herein can apply to a point of sale system in a physical retail shop or ecommerce online shopping system. In some embodiments device 212 may be a point of sale system in a retail shop or a shopping card web page on an Internet site.

Referring back to FIG. 2, during this initiation of fund transfer, the first user may select between a fiat currency and a digital token (shown as “T” in FIG. 2) native to the blockchain network 250 to conduct the fund transfer. The fund transfer system 200 may obtain an exchange rate between the fiat currency and the digital token via a token pricing provider 222. For example, the token pricing provider 222 may be an exchange, a plurality of exchanges, a pricing aggregator, a trusted party, and/or a combination thereof. The exchange rate may be obtained in real-time. The fund transfer system 200 may provide the transaction amount in fiat currency, digital token, and/or both based at least in part on the exchange rate to the first user and/or the second user during selection. In some instances, the first user may select fiat currency to conduct the transfer. In other instances, the first user may select digital token currency or a combination of fiat currency and digital currency to conduct the transfer.

Upon receiving instructions from the first user to use digital token currency to conduct the transfer, the fund transfer system 200 may (i) transfer, in the blockchain network 250, digital tokens from the first user's digital account 202 (e.g., digital wallet) to a digital account 204 of a central entity 206, (ii) instruct the central entity 206 to transfer a fiat currency equivalent (per the exchange rate obtained from the token pricing provider 222) of the digital token amount from its account to a clearing account, and (iii) instruct a clearing financial institution 208 having the clearing account to schedule a payment in fiat currency to the second user's account in the second user's financial institution 210. Processes (i)-(iii) may occur simultaneously or substantially simultaneously, such as to reduce time delay. At the end of the transaction, the first user may have transferred digital tokens from the first user's digital account 202 and the second user may have received fiat currency in the second user's account. In some instances, instead of fiat currency, the second user may receive digital tokens, such as by direct or indirect transfer, in the blockchain network 250, of digital tokens from the first user's digital account 202 to the second user's digital account. In some instances, the second user may receive a combination of fiat currency and digital tokens.

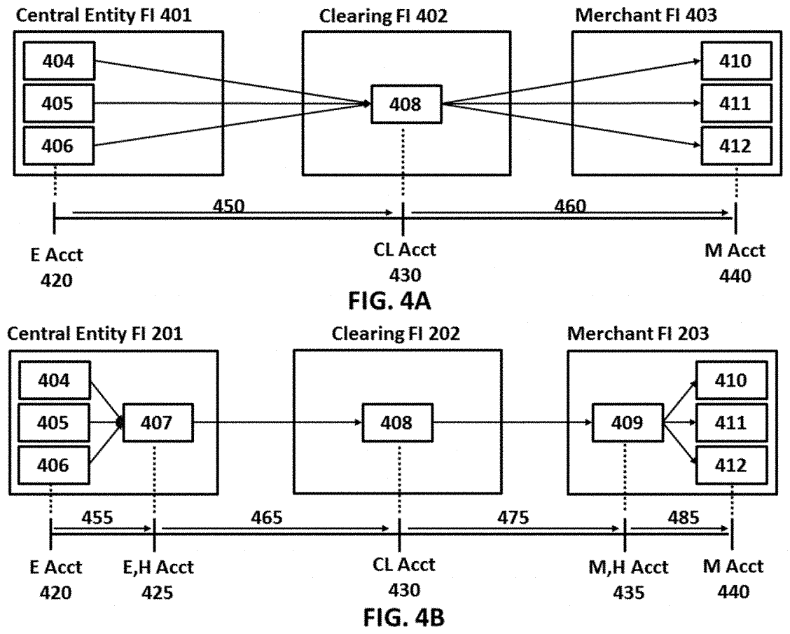

The benefits of having one or more intermediary clearing accounts (e.g., at a clearing FI 208) and/or intermediary holding accounts to facilitate fund transfers, such as by mitigating transfer cost and time, are described in further detail in FIGS. 4A-4B.

Provided herein are also methods for the first user to exchange and obtain digital token using fiat currency by transacting with the central entity. Upon the first user making a request for exchange, (i) the first user may transfer a fiat currency from the first user's financial account at the first user's financial institution to a clearing account of the clearing financial institution, and (ii) the central entity 206 may transfer a digital token amount equivalent (per the exchange rate obtained from the token pricing provider 222) of the fiat currency amount from its digital account 204 to the first user's digital account 202 on the blockchain network 250. At the end of the transaction, the first user may have received digital tokens in the first user's digital account 202 and the central entity may have (via the clearing account) received fiat currency.

Provided herein are also methods for the first user to exchange and obtain fiat currency using digital tokens by transacting with the central entity. Upon the first user making a request for exchange, (i) the first user may transfer a digital token amount from the first user's digital account 202 to the central entity's digital account 204 on the blockchain network 250, and (ii) the central entity 206 may transfer a fiat currency amount equivalent (per the exchange rate obtained from the token pricing provider 222) of the digital token amount from its clearing account to the first user's financial account at the first user's financial institution. At the end of the transaction, the first user may have received fiat currency in the first user's financial account at the first user's financial institution and the central entity may have received digital tokens in the digital account 204.

FIG. 3 shows a process flow for facilitating payment using graphical codes. In FIG. 3, the process(es) carried out by or involving a customer 302 (e.g., who may correspond to first user in FIG. 2) are represented by a contact with a vertical line 360, the process(es) carried out by or involving a fund transfer server 304 are represented by a contact with a vertical line 370, and the process(es) carried out by or involving an intended recipient 306 (e.g., who may correspond to the second user in FIG. 2) are represented by a contact with a vertical line 380.

A customer 302 can process a payment to a merchant 306 with aid of a fund transfer server 304. The merchant may send an invoice to the customer with aid of the fund transfer server. The customer may process the payment and/or communicate with the server with aid of a first user device 310, and the merchant may send the invoice and/or communicate with the server with aid of a second user device 312. The user devices can correspond to the user device 101, 102, 103, and 104 of FIG. 1.

When the customer 302 has unpaid dues to the merchant 306, for example, for purchase of goods or services form the merchant, the merchant can decide to send the customer an invoice. The invoice can be a paper invoice that is physically delivered or tendered to the customer. The invoice can be an electronic invoice that is electronically delivered, such as over a computer network. The invoice delivered to the customer can contain a QR code or other visual graphical indicia encoding information related to the invoice. The visual graphical indicia can be a visual graphical barcode of any format, such as a bar code, text, a picture, a sequence thereof, or the like that can be captured and/or displayed on a device. The visual graphical barcode may be a two-dimensional barcode, such as PDF417, Aztec, MaxiCode, and QR code, etc. The visual graphical barcode may be a one-dimensional barcode, such as Interleaved 2/5, Industrial 2/5, Code 39, Code 39 Extended, Codabar, Code 11, Code 128, Code 128 Extended, EAN/UCC 128, UCC/EAN-128, UPC-E, UPC-A, EAN-8, EAN-13, Code 93, Code 93 Extended, DataBar Omnidirectional (RSS-14), DataBar Truncated (RSS-14 Truncated), DataBar Limited (RSS Limited), DataBar Stacked, DataBar Expanded, and DataBar Expanded Stacked, etc. The visual graphical barcode can encode various types of information in any type of suitable format, such as binary, alphanumeric, ASCII, and other formats, and the code can be based on any standards. The visual graphical barcode may have various storage capacities that can encode a certain amount of data, and variable physical size. In some embodiments, the visual graphical barcode may conform to known standards that can be read by standard barcode readers. In other embodiments, the visual graphical barcode may be proprietary such that it can be read only by an authenticated application provided by an authentication system running on a user device. In some instances, only the fund transfer system or proprietary application and/or software deployed by the fund transfer system can be capable of encrypting/decrypting the visual graphical barcode. The visual graphical barcode can be a one-dimensional barcode, two-dimensional barcode or three-dimensional barcode. The visual graphical barcode can be, for example, one-dimensional barcode that includes linear patterns such as lines and spaces. The lines and spaces may be black-and-white. The lines and spaces can comprise more than one color. The color may be visible to human eyes. The color of the barcode may be distinguishable by special tools. For instance, the barcode may include print carbon lines which are detectable using an infrared scanner. The visual graphical barcode can be a two-dimensional barcode including various shapes. The visual graphical barcode may be static or dynamic. The visual graphical barcode may be changed or updated at a certain frequency. The frequency may vary widely in range, such as from 100 Hz to 0.001 Hz. Any description herein of a QR code can be applicable to any visual graphical barcode, and vice versa.

The merchant 306 can send 320 a QR code request to the fund transfer server 304. The QR code request can include information such as transaction details, a transaction identification number (ID) or any other information related to one or more transactions to be included in the invoice. For example, the QR code request can include at least all information that is printed on or included on the face of the invoice. Upon receipt of the QR code request from the merchant, the fund transfer server can generate 322 a QR code. The QR code can encode such transaction information provided by the merchant (e.g., transaction details, transaction ID, and/or any information related to one or more transactions to be included in the invoice, etc.). The fund transfer server can otherwise associate such transaction information to the QR code. The server can store such association information in memory, such as in a database. The server can send 324 the QR code to the merchant. Upon receipt of the QR code, the merchant can include 326 the QR code on the invoice to be sent to the customer. For example, the QR code can be printed on a paper invoice. In another example, the QR code can be attached or included in an electronic invoice. Alternatively or in addition, the fund transfer server can generate and send the merchant a code (e.g., alphanumeric code) or other data that the merchant can use to self-generate the QR code, and this code or other data can be associated with the transaction information in a database of the server.

The merchant 306 can then provide 328 the invoice with the QR code to the customer 302. In some instances, a paper invoice can be physically delivered or tended to the customer. In some instances, an electronic invoice can be electronically delivered to the customer, such as over a computer network. In some instances, an electronic invoice can be electronically delivered to the customer via the fund transfer server 304. In some instances, an electronic invoice can be displayed to the customer 302 over a display. For example, the electronic invoice can be displayed on a display provided by the merchant 306 or a display of the customer 302 (e.g., of a user device). The display may be, or be part of, a processing device (e.g., purchase processing device, cash register, etc.), a personal device (e.g., mobile phone, tablet, computer, monitor, etc.), or other device. Upon receipt of the invoice by the customer, the customer can use an optical sensor of the user device 310 to scan 330 the QR code on the invoice. In some instances, the user device 310 may execute scanning or optical recognition algorithms to identify, recognize, and/or scan a QR code from an electronic invoice accessed by the user device 310 without requiring a second device (a first device to display, and a second display to scan the display). Upon scanning of the QR code, the user device 310 can send a request 332 to the fund transfer server, requesting transaction information. The request can include one or more information (e.g., data, code, information uniquely encrypted in the QR code). Upon receipt of the request, the server can recall 334 the transaction information associated with the QR code, such as by searching the database of the server. The server can then send 336 the transaction information to the customer. The transaction information can be presented on an electronic display communicating with the user device 310. The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify 338 the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant. As described with respect to FIG. 2, the transaction information can include a fund transfer amount in fiat currency and/or digital token. Upon presentation of the fund transfer amount, with the approval, the customer may further select between the fiat currency and/or the digital token to conduct the transaction. Alternatively or in addition, the customer may have a default currency (either fiat currency or digital token) stored or otherwise associated with the customer's account, and the server 304 may use such default currency if no selection is made.

Alternatively, the customer (e.g., 302) can send a QR code request to the fund transfer server (e.g., 304). The QR code request can include information about the customer, such as the customer account information. In some instances, the QR code request can include information about the merchant (e.g., 306). In some instances, the QR code request can include information such as transaction details, a transaction identification number (ID) or any other information related to one or more transactions. For example, the QR code request can include at least all information that is printed on or included on the face of an invoice. Upon receipt of the QR code request from the customer, the fund transfer server can generate a QR code. The QR code can encode such customer account information provided by the customer. In some instances, the QR code can encode merchant information and/or transaction information provided by the customer (e.g., transaction details, transaction ID, and/or any information related to one or more transactions, etc.). The fund transfer server can otherwise associate such customer information, merchant information, and/or transaction information to the QR code. The server can store such association information in memory, such as in a database. The server can send the QR code to the customer. Alternatively or in addition, the fund transfer server can generate and send the customer a code (e.g., alphanumeric code) or other data that the customer can use to self-generate the QR code, and this code or other data can be associated with the transaction information in a database of the server.

Upon receipt of the QR code, the customer can present or otherwise display the QR code to the merchant. In some instances, the QR code can be printed on a paper and be physically delivered or tended to the merchant. In some instances, the QR code can be electronically delivered to the merchant, such as over a computer network. In some instances, the QR code can be electronically delivered to the merchant via the fund transfer server. In some instances, the QR code can be displayed to the merchant over a display. For example, the QR code can be displayed on a display provided by the customer (e.g., display of a user device) or a display of the merchant. The display may be, or be part of, a processing device (e.g., purchase processing device, cash register, etc.), a personal device (e.g., mobile phone, tablet, computer, monitor, etc.), or other device. Upon receipt of the QR code by the customer, the merchant can use an optical sensor of the a merchant device (e.g., purchase processing device, cash register, scanner, personal device, etc,) to scan the QR code. In some instances, the merchant device may execute scanning or optical recognition algorithms to identify, recognize, and/or scan the QR code without requiring a second device (a first device to display, and a second display to scan the display). Upon scanning of the QR code, the merchant device can send a request to the fund transfer server, requesting transaction information. The request can include one or more information (e.g., data, code, information uniquely encrypted in the QR code). Upon receipt of the request, the server can recall the customer and/or transaction information associated with the QR code, such as by searching the database of the server. In some instances, upon scanning of the QR code or simultaneously with scanning of the QR code, the merchant may transmit supplement information about the transaction (e.g., transaction details, merchant information, etc.) to the server. The server can then send the transaction information to the customer. The transaction information can be presented on an electronic display communicating with the customer user device (e.g., 310). The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant.

The customer 302 can be required to complete an authentication process before sending approval instructions to the server 304. For example, upon sending an intention to approve (e.g., selecting an “approve” or “confirm” option (user interactive component such as a button)) to the server, the server can send an authentication request to the customer. Alternatively, the customer can authenticate and approve simultaneously. Optionally, the customer can approve without separate authentication.

The authentication request may allow the individual to authenticate the individual's identity via biometric authentication. In some instances, the user device 310 and/or server 304 can individually or collectively comprise a biometric module for authentication. A biometric module may comprise hardware and software components for collecting, storing, processing, translating or analyzing biometric data. Biometric data may include any feature or output of an organism that can be measured and used to uniquely identify the organism. Biometric data may include, but are not be limited to, fingerprints, DNA, body temperature, face/hand/retina or ear features, behavioral characteristics such as typing rhythm, gait, gestures and voice. Hardware components in a biometric module may further comprise biometric readers, for example a fingerprint reader or retinal scanner, microprocessors, and RAM/ROM memory. Software components may comprise one or more software-based programs, including applications, protocols, or plugins, configured for collecting and/or processing biometric data from the hardware components of the biometric module. In some instances, collection and processing biometric data may comprise steps for analyzing the biometric data, creating a template (i.e. digital template) for biometric data, storing, matching, and verifying the biometric data (i.e. with an external database or previously stored information). In some embodiments, a biometric reader may also be coupled to a user device through wired or wireless connections. Wireless connections may include one or more types of Wi-Fi or peer-to-peer (P2P) networking protocols. In other embodiments, a biometric reader may be built into the web-enabled device. In some embodiments, the biometric module may be included, installed, or attached to the user device 310.

Alternatively or in addition, the authentication request may allow authentication via user credentials (e.g., PIN, password, passcode, cryptographic proof, etc.). For example, prior to authentication, a user (e.g., customer 302) may have provided the fund transfer server 304 with such user credentials, such as during or after registration with the server. Alternatively, or in addition, the authentication request may allow authentication via device (e.g., one-time password device, user device, etc.) authentication. Alternatively or in addition, the authentication request may allow authentication via third party service authentication (e.g., authentication via social networking system account, authentication via verified email account, etc.). If a recipient fails authentication, for example for a certain number of times (e.g., 3), the server may try contacting the customer 302 via a contact address (e.g., phone number, email address, etc.) to alert the customer 302 of possible fraud.

In some instances, the approval and/or authentication request may expire after a finite duration of time. An invoice may expire after a finite duration of time. For example, the request sent by the server 304 or invoice may expire after a certain period of time, such as in 10 seconds, 30 seconds, 1 minute, 5 minutes, 10 minutes, 30 minutes, 1 hour, 2 hours, 3 hours, 4 hours, 5 hours, 6 hours, 7 hours, 8 hours, 9 hours, 10 hours, 11 hours, 12 hours, 15 hours, 18 hours, 21 hours, 1 day (e.g., 24 hours), 2 days, 3 days, 4 days, 5 days, 6 days, 1 week (e.g., 7 days), 2 weeks, 3 weeks, 4 weeks, 1 month, 2 months, 3 months, 4 months, 5 months, 6 months, 9 months, 12 months, 1 year, 2 years, 3 years, or other duration of time. A QR code can have an expiration date. If a user does not provide approval and/or authentication within the certain period of time, the merchant 306 can be alerted, such as to encourage renewal of an invoice or remind payment of the invoice to the customer 302. In some instances, the QR code can include additional information, such as due date or due time of the payment, a number of times an invoice has been presented to the customer for payment, tax category of the payment, and/or other information. In some instances, upon expiration of an invoice, upon scanning of a QR code (e.g., after the due date or due time of the payment), the server can generate an error message informing the customer of the expiration. Alternatively, the request may not expire, and the customer may provide approval and/or authentication at any time.

With or after authentication, the customer 302 can send 340 approval instructions of the invoice to the fund transfer server 304. The approval instructions can instruct payment of the invoice to the merchant. In some instances, the approval instructions can include payment information required for payment of the invoice. In some instances, the payment information can be pre-stored in one or more secure (e.g., encrypted) databases of the server and the approval instructions can include approval from the customer for the server to use such payment instructions. Alternatively or in addition, the customer can manually input such payment information with or after authentication, and/or with approval. In some instances, the payment information can include the selection between digital tokens and fiat currency.

Upon receipt of the approval instructions, the server 304 can request 342 a transfer of funds from a customer 302 account to a merchant 306 account. For example, as described with respect to FIG. 2, this can comprise the server (i) transferring, in the blockchain network 250, digital tokens from the first user's digital account 202 (e.g., digital wallet) to a digital account 204 of a central entity 206, (ii) instructing the central entity 206 to transfer a fiat currency equivalent (per the exchange rate obtained from the token pricing provider 222) of the digital token amount from its account to a clearing account, and (iii) instructing a clearing financial institution 208 having the clearing account to schedule a payment in fiat currency to the second user's account in the second user's financial institution 210, where the first user is the customer 302 and the second user 306 is the merchant in FIG. 3. Specifics of the payment can be provided by the customer (e.g., in the approval instructions, payment preferences for the customer, etc.) and/or the merchant (e.g., in the invoice, payment preferences for the merchant, etc.). The transfer of funds can be made on one or more blockchain networks. The transfer of funds can be requested to one or more financial institutions. In some instances, the transfer of funds can be achieved via systems and methods described elsewhere herein (e.g., breaking up the transfer process, clearing accounts, holding accounts, multiple clearing accounts, multiple holding accounts, timing, optimizing transfer time and cost, etc.). After receiving confirmation of fund transfer from one or more FIs, the server can mark the particular transaction ID as completed and/or the invoice as paid. Such completion information can be stored in one or more databases of the fund transfer server. The one or more databases of the server can be searchable. The one or more databases can individually or collectively perform or implement systems and methods described herein. Upon confirmation of fund transfer, the server 304 can then send 344A an invoice receipt to the customer 302 and send 344B a notice of the fund transfer to the merchant 306. In some instances, the invoice receipt and the notice of the fund transfer can be sent simultaneously. In some instances, the invoice receipt can be sent before confirmation of successful fund transfer, but after approval instructions are sent by the customer. In some instances, the invoice receipt can be sent after a request for a fund transfer is made to one or more FIs by the fund transfer server. For example, if a fund transfer fails after the request, the server can update the customer with such error and update the server databases to mark the transaction ID as incomplete.

At any point in time during the process, the merchant 306 can request from the server 304 a query about the status of invoices for the merchant. Upon receiving such query, the server 304 can scan the one or more databases for transaction IDs associated with the merchant to determine 348 the payment status of invoices for the merchant. For example, statuses of the invoices can include, but are not limited to, paid, unpaid, expired, overdue, cancelled, refunded, or other statuses. The server can send 350 such data, such as a list of unpaid invoices (e.g., transaction IDs) and/or a list of paid invoices, to the merchant. The user device 312 of the merchant 306 can be capable of presenting such data to the merchant, such as on a graphical user interface on an electronic display communicatively coupled to the user device 312. Alternatively or in addition, the customer 302 can request from the server a query on the status of invoices for the customer. Alternatively or in addition, the server may automatically provide, without manual request, a list of paid invoices and/or unpaid invoices, or invoices with other statuses, to a customer and/or merchant. For example, such lists can be provided periodically (e.g., annually, monthly, quarterly, biannually, bimonthly, weekly, biweekly, etc.), such as a part of a report. For each invoice, such list and/or report generated by the server can include information such as, payor (e.g., customer), payee (e.g., merchant), invoice number (e.g., transaction ID), amount paid, due date, payment date, method of payment, and/or other information related to a given invoice and/or payment of the given invoice. A report and/or list (e.g., requested or automatically generated) provided by the server can be filtered, sorted, and/or searched, such as by invoice status, by customer, by merchant, by due date, by invoice amount, and/or by any other data on or relating to the invoice.

Accounting data, such as reports and/or lists generated by the server 304, or any previous invoices using the fund transfer server can be imported by a user (e.g., customer, merchant), such as for incorporation into existing reports, statements, tax software, and/or accounting sheets.

While FIG. 3 shows one fund transfer server 304, there may be one or more fund transfer servers, collectively or individually, implementing the functions of the fund transfer server 304 described herein. For example, a first fund transfer server can generate the QR code, a second fund transfer server can facilitate transfer of funds, and a third fund transfer server can facilitate accounting by providing reports or list of paid and/or unpaid invoices.

In some instances, a customer and/or merchant may discover exceptions or errors in one or more invoices before or after payment by the customer. The customer and/or merchant can generate and/or report such exceptions to the server 304. The server can send the exception report to a payee FI, request reversal of payments made in error, inform the payee of the reversal, and/or thereafter send confirmation of corrected or updated electronic receipt for the refund.

Beneficially, translating such transaction and/or invoice information into electronic storage can provide long term storage. Further, allowing access of such information via scanning a QR code can facilitate convenient payment and/or accounting of invoices. For example, even if a paper invoice provides all information required or desired for payment (e.g., to a customer, from a merchant), such paper invoice can be lost easily, damaged (e.g., fading ink, torn, ripped, wrinkled, crumpled, folded, etc.), and accounting errors can be made while translating or transferring one or more information on the invoice (e.g., amount paid, amount to be paid) to an accounting sheet (e.g., hard copy or electronic) or accounting device (e.g., calculator).

In some embodiments, the invoice may be provided from the merchant to the customer without a QR code. The customer can scan the invoice without the QR code with an optical sensor (e.g., camera) on a user device. The optical sensor can, in conjunction with one or more OCR algorithms, read and recognize text and/or numbers from the invoice. Based on such reading and recognition, the server can identify the information needed for processing payment and automatically present such information to the customer, such as on a graphical user interface, for verification. Operations 338-344 can follow thereafter. In some instances, to aid accuracy of the one or more OCR algorithms, the server can provide an invoice template to the merchant. Alternatively or in addition, a merchant can provide an invoice template to the server. The one or more OCR algorithms can then be tailored to accurately recognize certain information from the invoice template (e.g., coordinate location of information relative to boundaries of an invoice). In some embodiments, QR codes can be pre-generated for goods or services (for sale).

Any and all communications between the customer 302, fund transfer server 304, and/or merchant 306 can be electronic (e.g., via electronic mail, via server user interface, etc.) or non-electronic (e.g., physically delivered, physically communicated). The customer and the merchant can be in the vicinity of each other (e.g., in same store, same restaurant, same gas station, etc.). The customer and merchant can be remote from each other. As a result, while FIG. 3 illustrates invoice payment between a customer and a merchant, the payments are not limited as such. The descriptions herein can apply to a point of sale system in a physical retail shop or ecommerce online shopping system.

With reference to FIGS. 4A-4B, one or more intermediary clearing accounts and/or intermediary holding accounts may facilitate fund transfers, such as by mitigating transfer cost and time. To complete a fund transfer (e.g., for funds to leave a source account and arrive at a recipient account), funds may undergo a clearing process. During clearing of a transfer, one or more FIs may perform operations such as regulating, monitoring, reporting, settling, handling taxes and costs, managing failures or errors, and/or determining margins. The systems and methods described herein can significantly reduce interbanking and/or intrabanking costs and time. For example, in some instances, the FI of the consumer and the merchant FI may be the same FI and the lowest cost transfer path may be via an “on us” transfer. Such transfers within the same FI may be completed without significant cost or time delay. For example, such “on us” transfers may be completed at relatively little or no cost. “On us” transfers may be completed instantaneously or substantially instantaneously. “On us” transfers may be completed in relatively shorter durations of time (e.g., within a business day, 2 business days, etc.). Alternatively or in addition, the lowest cost transfer path may pass through one or more interbanking networks. For example, the interbanking network can be the Automated Clearing House (ACH) network or the Electronic Payment Network (EPN) in the United States, Zengin-Net network in Japan, CECOBAN in Mexico, PostFinance in Switzerland, ACSS in Canada, or other networks. The interbanking network may be international banking networks (e.g., SWIFT, Fedwire, etc.). Any description herein of ACH or a clearing house (e.g., bank) may apply to any other type of interbanking network, entity, or system within the U.S., in another country, or across a plurality of countries. In other instances, the consumer FI and the merchant FI may be different FIs, and the transfer may pass through the ACH network. Alternatively or in addition, fund transfers may be performed via wire transfers, which can be costly but with shorter processing and/or clearing periods. The transfer of value between financial institutions (e.g., banks) using blockchain and cryptocurrency, as described herein, may be an interbank value transfer.

A transfer passing through one or more interbanking networks (e.g., ACH, Zengin-Net, SWIFT, etc.) may incur a transactional cost or fee which is forwarded to the sender, the recipient, and/or the FI of either. The transactional cost or fee can be on a per transfer basis, per amount basis, per client basis, or other bases. Furthermore, a transfer passing through one or more interbanking networks may be delayed on the order of days (e.g., at least 1 business day, 2 business days, 3 business days, 4 business days, 5 business days, 6 business days, 7 business days, or longer), such as to comply with regulations, ensure clearing, and/or protect against fraudulent transfers. Different FIs may charge different fees (e.g., by taking the cost of the transfer), and/or offer different delivery (e.g., transfer, clearing, etc.) time.

FIG. 4A shows a schematic transfer flow from a central entity account to a merchant account with an intermediary clearing account and a corresponding timeline of the transfer flow. One or more central entities may be accountholders at a central entity FI 401, and one or more merchants may be accountholders at a merchant FI 403. Funds may be transferred from a central entity account (e.g., one of central entity accounts 404, 405, 406) to a merchant account (e.g., one of merchant accounts 410, 411, 412), such as by passing through an intermediary clearing account 408 at a clearing FI 402. An account can be a checking account, savings account, line of credit, deposit account, general ledger (GL) account, or other type of account. The central entity FI 401, clearing FI 402, and merchant FI 403 may each be the same FI, different FIs, or two of the FIs can be the same FI and the third a different FI. In some instances, the funds may be transferred directly from a central entity account to a merchant account without passing through a clearing account.

A transfer can be initiated by the central entity, such as by submitting a request to ‘push’ funds to a merchant, from a central entity account 404 to a merchant account 410. Alternatively, a transfer can be initiated by the merchant, such as by submitting a request to ‘pull’ funds (e.g., automatic bill payment, etc.) from a central entity. Such requests, commands, and/or instructions can be made electronically and/or online. Upon initiation of the transfer, the fund transfer system (e.g., system 100 in FIG. 1) can first initiate a transfer from a central entity account 404 to an intermediary clearing account 408. An ACH process may be used. Alternatively, an “on us” transfer may be completed between the central entity account and the intermediary clearing account, for example, if the central entity FI 401 and the clearing FI 402 are the same FI.

The intermediary clearing account 408 can belong to an intermediary. The intermediary can be a third party to the transfer that is neither the central entity (e.g., sender) nor the merchant (e.g., intended recipient). For example, the intermediary may be an operator, administrator, and/or online service provider of the fund transfer system. The intermediary can be a party to the transfer. The intermediary can be a correspondent bank. An intermediary clearing account may provide increased security between central entity accounts and merchant accounts which do not have to release sensitive financial information (e.g., account information, etc.) to the other to complete the transfer. In some instances, the intermediary may provide convenient payment processing or financial transaction platforms or hubs (e.g., user friendly GUI, etc.) to facilitate fund transfer between two users. The intermediary may provide convenient services that a transferor (e.g., central entity) or transferee (e.g., merchant) uses to initiate the transfer.

The fund transfer system can then initiate a transfer from the intermediary clearing account 408 to the merchant account 410. An ACH process may be used. A SWIFT process may be used. Alternatively, an “on us” transfer may be completed between the central entity account and the intermediary clearing account, for example, if the clearing FI 402 and the merchant FI 403 are the same FI. An ACH or SWIFT process may require at least one business day, two business days, three business days, four business days, five business days, or longer to complete. In some instances, a FI may offer faster delivery for additional cost.

Similarly, upon request for other transfers from accounts at the central entity FI 401 to accounts at the merchant FI 403, such as requests to transfer from central entity accounts 204, 205, and/or 206 to merchant accounts 410, 411, and/or 412, the fund transfer system can direct the transfers through the intermediary clearing account 408 at the clearing FI 402. Beneficially, the intermediary clearing account can aggregate and accumulate buffer funds as different funds at different points in time pass through the intermediary clearing account. When there are sufficient buffer funds available in the intermediary clearing account, upon initiation of the transfer by the central entity, the fund transfer system may initiate transfers between (i) the central entity account and the intermediary clearing account, and (ii) the intermediary clearing account and the merchant account, substantially simultaneously or with relatively short time lapse (e.g., less than one business day).

A timeline is illustrated. A transfer between a central entity FI and merchant FI may be a two part transfer, wherein a first transfer 450 is made from a central entity account 420 to an intermediary clearing account 430 and a second transfer 460 is made from the intermediary clearing account 430 to a merchant account 440. In some instances, the second transfer 460 may be initiated upon completion of the first transfer 450. Such transfers can take the length of two separate inter-banking transfers. In other instances, the first transfer 450 and the second transfer 460 may be initiated substantially simultaneously or with relatively short time lapse. Beneficially, such transfers can take the length of only one interbanking transfer because they are carried out substantially simultaneously.

While FIG. 4A shows exemplary fund transfer paths, the fund transfer paths are not limited as such. In some instances, a transfer path can include any number of intermediary clearing accounts, wherein the funds pass through sequentially or selectively. Such intermediary clearing accounts may be managed or owned by the same or different intermediaries. While FIG. 4A illustrates transfers between a central entity and a merchant, the parties are not limited as such. The descriptions herein can apply to a transfer between any transferor (e.g., central entity, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

FIG. 4B shows a schematic transfer flow from a central entity account to a merchant account with an intermediary clearing account and intermediary holding accounts and a corresponding timeline of the transfer flow. One or more central entities may be accountholders at a central entity FI 401, and one or more merchants may be accountholders at a merchant FI 403. Funds may be transferred from a central entity account (e.g., one of central entity accounts 404, 405, 406) to a merchant account (e.g., one of merchant accounts 410, 411, 412), such as by passing through an intermediary central entity FI holding account 407, intermediary clearing account 408 at a clearing FI 402, and intermediary merchant FI holding account 409. The central entity FI 401, clearing FI 402, and merchant FI 403 may each be the same FI, different FIs, or two of the FIs can be the same FI and the third a different FI. In some instances, the funds may be transferred directly from a central entity account to a merchant account without passing through an intermediary clearing account and/or without passing through one or more intermediary holding accounts.

A transfer can be initiated by the central entity, such as by submitting a request to ‘push’ funds to a merchant, from a central entity account 404 to a merchant account 410. Alternatively, a transfer can be initiated by the merchant, such as by submitting a request to ‘pull’ funds (e.g., automatic bill payment, etc.) from a central entity. Such requests, commands, and/or instructions can be made electronically and/or online. Upon initiation of the transfer, the fund transfer system (e.g., system 100 in FIG. 1) can first initiate a transfer from a central entity account 404 to an intermediary central entity FI holding account 407. The central entity account and the intermediary central entity FI holding account can both be at the same central entity FI 401. An “on us” transfer may be completed between the central entity account and the intermediary central entity FI holding account. Such “on us” transfers may incur relatively little or no cost and be completed in relatively less time than other transfer processes.

An intermediary holding account (e.g., intermediary central entity FI holding account 407, intermediary merchant FI holding account 409, etc.) can belong to an intermediary. The same intermediary can own both the intermediary holding account and the intermediary clearing account 408. In some instances, the intermediary can own an intermediary holding account at each FI, for example, for which there is a transfer to or from a given FI. In some instances, the intermediary can be a financial institution. The intermediary can own a plurality of intermediary holding accounts at each FI. An intermediary holding account may provide increased security for the transfer, such as to prevent fraud, and hold necessary funds set aside for transfer for clearing. Beneficially, at a time of purchase, funds transferred substantially instantaneously from a central entity account to an intermediary holding account can guarantee the funds for the merchant. FIs for which the intermediary has an intermediary holding account can be referred to as an “in-network” FI and FIs for which the intermediary does not have an intermediary holding account may be referred to as an “out of network” FI.

The fund transfer system can then initiate a transfer from the intermediary central entity FI holding account 407 to an intermediary clearing account 408. An ACH process may be used. Alternatively, an “on us” transfer may be completed, for example, if the central entity FI 401 and the clearing FI 402 are the same FI. The fund transfer system can then initiate a transfer from the intermediary clearing account 408 to an intermediary merchant FI holding account 409. An ACH or SWIFT process may be used. Alternatively, an “on us” transfer may be completed, for example, if the clearing FI 402 and the merchant FI 403 are the same FI. The fund transfer system can then initiate a transfer from the intermediary merchant FI holding account 409 to the merchant account 410. An “on us” transfer may be completed between the intermediary merchant FI holding account and the merchant account. Such “on us” transfers may incur relatively little or no cost and be completed in relatively less time. “On us” transfers can be instantaneous or substantially instantaneous.

Similarly, upon request for other transfers from accounts at the central entity FI 401 to accounts at the merchant FI 403, such as requests to transfer from central entity accounts 404, 405, and/or 406 to merchant accounts 410, 411, and/or 412, the fund transfer system can direct the transfers first through the intermediary central entity FI holding account 407, then to the intermediary clearing account 408 at the clearing FI 402, and then to the intermediary merchant FI holding account 409. Beneficially, an intermediary holding account can aggregate and accumulate funds for an accumulated transfer to and from the intermediary clearing account 408. This may significantly reduce overall transfer costs, such as where interbanking transfer costs are incurred on a per transaction or per client basis.

Beneficially, the intermediary clearing account 408 can aggregate and accumulate buffer funds as different funds at different points in time pass through the intermediary clearing account. When there are sufficient buffer funds available in the intermediary clearing account, upon initiation of the transfer by the central entity, the fund transfer system may initiate transfers between (i) the intermediary central entity FI holding account and the intermediary clearing account, and (ii) the intermediary merchant FI holding account and the intermediary clearing account, substantially simultaneously or with relatively short time lapse (e.g., less than one business day). Additionally, the fund transfer system may initiate transfers between (i) the central entity account and the intermediary central entity FI holding account, and/or (ii) the intermediary merchant FI holding account and the merchant account, substantially simultaneously or with relatively short time lapses with the other transfers.

A timeline is illustrated. A transfer between a central entity FI and merchant FI may be a four part transfer, wherein a first transfer 455 is made from a central entity account 420 to an intermediary central entity FI holding account 425, a second transfer 465 is made from the intermediary central entity FI holding account 425 to an intermediary clearing account 430, a third transfer 475 is made from the intermediary clearing account 430 to an intermediary merchant FI holding account 435, and a fourth transfer 485 is made from the intermediary merchant FI holding account 435 to a merchant account 440. In some instances, each transfer may be initiated upon completion of the previous transfer (e.g., second transfer 465 after first transfer 455, third transfer 475 after second transfer 465, fourth transfer 485 after third transfer 475). Such transfers can take the length of four separate transfers, which length may vary with whether each transfer is an interbanking transfer or an intrabanking (e.g., “on us”) transfer. In other instances, one or more transfers may be initiated substantially simultaneously or with relatively short time lapse. For example, all four transfers may be initiated substantially simultaneously. In another example, the second transfer 465 and the third transfer 475 may be initiated simultaneously, but only after the completion of the first transfer 455. In another example, the fourth transfer 485 may be initiated only after completion of the second transfer 465 and the third transfer 475, which may or may not be completed simultaneously. Beneficially, such transfers can reduce total transfer time. Thus, both transfer cost and time can be reduced.

Buffer funds can be provided in intermediary accounts (e.g., intermediary holding accounts, intermediary clearing accounts, etc.) to facilitate simultaneous transfers. In some instances, an intermediary account can be linked to, or implemented as, loan accounts from the financial institution in which the intermediary account is located. Beneficially, when insufficient buffer funds are available in the intermediary account, an overdraw of funds from the intermediary account can be immediately and automatically substituted with loans (e.g., short-term loans, long-term loans) from the financial institution such that the transfer can proceed without delay. The loans can be paid back as soon as other funds are propagated through the transfer chain. Such transfers may or may not incur interest on such loans.

While FIG. 4B shows exemplary fund transfer paths, the fund transfer paths are not limited as such. In some instances, a transfer path can include any number of intermediary clearing accounts, wherein the funds pass through sequentially or selectively. In some instances, a transfer path can include any number of intermediary holding accounts, wherein the funds pass through sequentially or selectively. Such intermediary clearing accounts and/or holding accounts may be managed or owned by the same or different intermediaries. While FIG. 4B illustrates transfers between a central entity and a merchant, the parties are not limited as such. The descriptions herein can apply to a transfer between any transferor (e.g., central entity, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

Beneficially, the shortened timeline illustrated with respect to FIGS. 4A-4B can be implemented for the digital token transfer described with respect to FIG. 2 or even further streamlined, in addition to the time savings described with respect to FIGS. 4A-4B, when the digital token transfer on the blockchain network (e.g., 250) is initiated simultaneously or substantially simultaneously with one or more of the inter-FIs or intra-FI processes (e.g., 450, 460, 455, 465, 475, 485, etc.).

In some instances, the transfers in the systems and methods described herein, such as above or further below, may only be initiated by the sender, transferor, and/or owner of the source account (e.g., originating account). For example, transfers may only be initiated as ‘push’ transfers. The system and methods may disallow ‘pull’ transfers that can be initiated by the recipient, transferee, and/or owner of the receiving account. Pull transfers can be debit transfers from a source account. Examples of pull transfers include, but are not limited to, automated billing payments, automated utility payments, payment refunds, and/or subscription payments. Pull transfers can be initiated by a receiving account. Push transfers can be credit transfers to a receiving account. Examples of push transfers include, but are not limited to, payroll direct deposits, cash, checks, government payments, wire transfers, and/or invoice payments. Push transfers can be initiated by a source account. Beneficially, a push transfer cannot be processed unless there are sufficient funds in the source account, unlike pull transfers, which can process the transfer and as a result render a negative balance in the source account. Furthermore, holding time of funds can be reduced for push transfers because transfers can be pre-verified by the sending bank (e.g., FI), unlike pull transfers, where transfers can be verified with the sending bank to prolong holding time. In some embodiments, each transfer facilitated by the systems and methods described herein may be a push transfer. In some instances, push transfers can depend on the ACH process and/or regulations imposed by one or more jurisdictions in which the transfers occur.

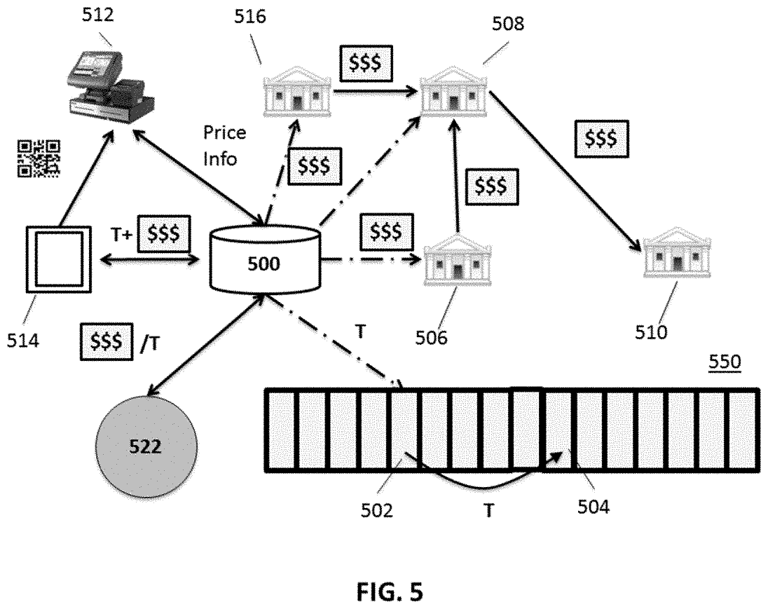

FIG. 5 illustrates another example of a transaction flow with a blockchain network involving fiat currency and digital token exchange. A first user (e.g., consumer) may use user device 514 and a second user (e.g., merchant) may use user device 512 to initiate a fund transfer between the first user and the second user, such as via using graphical codes (e.g., quick response (QR) codes) and communicating with the fund transfer system 500. The fund transfer system 500 can comprise and/or be in communication with blockchain network 550. In some instances, the user devices 512, 514 may correspond to user devices 101, 102, 103, 104 in FIG. 1, the fund transfer system 500 may correspond to the fund transfer system 100 in FIG. 1, and the blockchain network 550 may correspond to the blockchain network 150 in FIG. 1. The communication between the user device 514, user device 512, and the fund transfer system 500, including graphical codes, is described in further detail with respect to FIG. 3. While FIG. 3 illustrates invoice payment between a customer and a merchant, the payments are not limited as such. The descriptions herein can apply to a point of sale system in a physical retail shop or ecommerce online shopping system. In some embodiments device 512 may be a point of sale system in a retail shop or a shopping card web page on an internet site.

Referring back to FIG. 5, during this initiation of fund transfer, the first user may select between a fiat currency and a digital token (shown as “T” in FIG. 5) native to the blockchain network 550 or a combination of the two to conduct the fund transfer. The fund transfer system 500 may obtain an exchange rate (e.g., in real-time) between the fiat currency and the digital token via a token pricing provider 522. In some instances, the token pricing provider 522 may correspond to the token pricing provider 222 in FIG. 2. The fund transfer system 500 may display the transaction amount in fiat currency, digital token, and/or both based at least in part on the exchange rate to the first user and/or the second user during selection. In some instances, the first user may select to conduct the transfer in hybrid currencies, such as using both digital tokens and fiat currency.

Upon receiving instructions from the first user to use hybrid currency to conduct the transfer, the fund transfer system 500 may (i) transfer, in the blockchain network 550, digital tokens from the first user's digital account 502 (e.g., digital wallet) to a digital account 504 of a central entity 506, (ii) transfer fiat currency from the first user's account at the first user FI 516, (iii) instruct the central entity 506 to transfer a fiat currency equivalent (per the exchange rate obtained from the token pricing provider 522) of the digital token amount from its account to a clearing account, and (iv) instruct a clearing financial institution 508 having the clearing account to schedule a payment in fiat currency to the second user's account in the second user's financial institution 510. Processes (i)-(iv) may occur simultaneously or substantially simultaneously, such as to reduce time delay as described elsewhere herein. At the end of the transaction, the first user may have transferred both digital tokens from the first user's digital account 502 and fiat currency form the first user's account (e.g., bank account) and the second user may have received fiat currency in the second user's account for the total amount of the purchase. Alternatively, in some instances, the first user may select to conduct the transfer in digital tokens, and the second user may receive such digital tokens without the need for exchange.

Referring back to FIG. 3, for the example described above, upon receipt of the approval instructions from the customer 302, the server 304 can request 342 a transfer of funds from a customer 302 account to a merchant 306 account by (i) transferring, in the blockchain network 550, digital tokens from the first user's digital account 502 (e.g., digital wallet) to a digital account 504 of a central entity 506, (ii) transferring fiat currency from the first user's account at the first user FI 516, (iii) instructing the central entity 506 to transfer a fiat currency equivalent (per the exchange rate obtained from the token pricing provider 522) of the digital token amount from its account to a clearing account, and (iv) instructing a clearing financial institution 508 having the clearing account to schedule a payment in fiat currency to the second user's account in the second user's financial institution 510, where the first user is the customer 302 and the second user 306 is the merchant in FIG. 3.

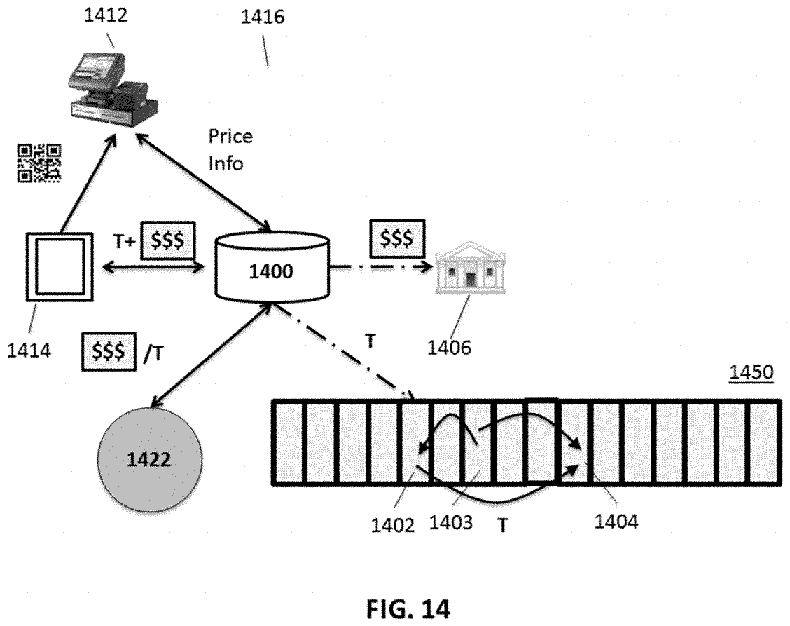

FIG. 14 illustrates another example of a transaction flow with a blockchain network involving fiat currency and digital token exchange, involving reimbursements. A first user (e.g., consumer) may use user device 1414 and a second user (e.g., merchant) may use user device 1412 to initiate a fund transfer between the first user and the second user, such as via using graphical codes (e.g., quick response (QR) codes) and communicating with the fund transfer system 1400. The fund transfer system 1400 can comprise and/or be in communication with blockchain network 1450. In some instances, the user devices 1412, 1414 may correspond to user devices 101, 102, 103, 104 in FIG. 1, the fund transfer system 1400 may correspond to the fund transfer system 100 in FIG. 1, and the blockchain network 1450 may correspond to the blockchain network 150 in FIG. 1. The communication between the user device 1414, user device 1412, and the fund transfer system 1400, including graphical codes, is described in further detail with respect to FIG. 3. While FIG. 3 illustrates invoice payment between a customer and a merchant, the payments are not limited as such. The descriptions herein can apply to a point of sale system in a physical retail shop or ecommerce online shopping system. In some embodiments device 1412 may be a point of sale system in a retail shop or a shopping card web page on an internet site.

Referring back to FIG. 14, during this initiation of fund transfer, the first user may select between a fiat currency and a digital token (shown as “T” in FIG. 14) native to the blockchain network 1450 or a combination of the two to conduct the fund transfer. The fund transfer system 1400 may obtain an exchange rate (e.g., in real-time) between the fiat currency and the digital token via a token pricing provider 1422. In some instances, the token pricing provider 1422 may correspond to the token pricing provider 222 in FIG. 2. The fund transfer system 1400 may display the transaction amount in fiat currency, digital token, and/or both based at least in part on the exchange rate to the first user and/or the second user during selection. In some instances, the first user may select to conduct the transfer in hybrid currencies, such as using both digital tokens and fiat currency.

Upon receiving instructions from the first user to use digital token currency to conduct the transfer, the fund transfer system 1400 may (i) transfer, in the blockchain network 1450, digital tokens of a first digital token amount from the first user's digital account 1402 (e.g., digital wallet) to the second user's digital account 1404, wherein such first digital token amount is an amount including reimbursement amount (e.g., taxes), (ii) transfer, in the blockchain network 1450, digital tokens of a second digital token amount from the digital account 1403 of the central entity 1406 to the first user's digital account 1402, wherein such second digital token amount is an amount of reimbursement, and optionally (iii) transfer, in the blockchain network 1450, digital tokens of a third digital token amount from the digital account 1403 of the central entity 1406 to the second user's digital account 1404, wherein the third digital token amount is an incentive or reward amount for conducting the transaction in the digital token currency. At the end of the transaction, the first user may have received a reimbursement, and the second user may have received an incentive or reward. In some instances, the reimbursement amount may function as an incentive or reward.

The central entity described herein, such as the central entity 206 and the central entity 506, may play a central role in facilitating transactions between the sender, the recipient, the financial institution(s), and third-party exchanges. The central entity may operate via a smart contract that holds the primary reserve of uncirculated digital tokens in the blockchain network. It may have access to fiat accounts in one or more financial institutions, such as to insure that accounts are verified as being active and transactions are initiated and/or completed. For example, it may have access to one or more clearing accounts and/or holding accounts described herein. The central entity may execute the monetary policy of the blockchain network, including the management of digital token rewards amongst users of the blockchain network. Control of the central entity may be decentralized, and its governance may be determined based on the percentage of outstanding ownership of the digital tokens in circulation. Users having at least a threshold percentage may have equal governing rights. Alternatively or in addition, users having more digital token ownership may have more ownership rights than users having less digital token ownership. In some instances, users accepting and processing more digital tokens, such as merchants and financial institutions, may have more governing rights than users accepting and processing fewer digital tokens. A combination of various methods of governing rights, including the selection of representative(s), may be used. The central entity may further communicate with third-party exchanges or other trusted entities to determine a spot price for the digital tokens used in transactions. In some instances, based at least on the spot price and/or a reference price, the central entity may interact with third-party exchanges to buy and sell digital tokens of the blockchain network as necessary to maintain a reserve of the digital tokens and/or fiat currency within a desired range. The central entity may further buy and sell digital tokens, and other objects or credits of value, such as US Treasury Bonds, Gold, Silver, and the like, as part of an economic policy for governing the fund transfer system (e.g., 100, 200, 500, etc.).

In some instances, the central entity may have received verification of identities of one or more users registered with the central entity. A real world identity of any user registered in the central entity may be initially verified by an authoritative entity, such as but not limited to an official government entity, a financial institution, an airline company, a rental company (e.g., rental cars, rental furniture, etc.), and/or a retail merchant providing financial services (e.g., issuing credit card with their own brand or co-branded with major credit card company, etc.). Such authoritative entity may be a centralized entity capable of verifying the real world identity of a user, such as via methods or techniques of their own selection (e.g., hard copy documents as evidence, in-person interview, requirement of identification numbers such as the social security number or passport number, etc.). For example, a financial institution (e.g., bank, insurance company, stock exchange, brokerage, etc.) may require and verify personal information of a user that receives financial services from such institution. An airline company may require and verify personal information of a user (e.g., legal name, sex, date of birth, etc.) to register the user as a frequent user (e.g., frequent flier). A user who completes at least one travel may have their identity verified by the airline company and/or the relevant government authorities (e.g., transportation security administration (TSA) or border control authorities, etc.). A rental company (e.g., rental car company) may require and verify identification documents (e.g., driver license, credit card information, etc.) from a user receiving rental services from such company. A retail merchant providing financial services (e.g., issuing credit card with their own brand or co-branded with a major credit card company) may perform the same or similar identity verification procedures as financial institutions. In some instances, the real world identity of a user may be verified via an account with the authoritative entity. In some instances, the authoritative entity may be a higher education institution, such as a college or university that independently verifies the real world identity of a user. In some instances, the central entity may verify a real world identity of a user by receiving hashed information from the authoritative entity, wherein the hashed information is accessible only by the authoritative entity and/or the user. In some cases, with reference to FIG. 2, if both users (first user and second user) are verified by the authoritative entit(ies) which provide the digital token accounts (e.g., wallets) to the users, the second user may receive digital tokens, such as by direct or indirect transfer, in the blockchain network 250, from the first user's digital account 202 to the second user's digital account, without passing through the central entity.

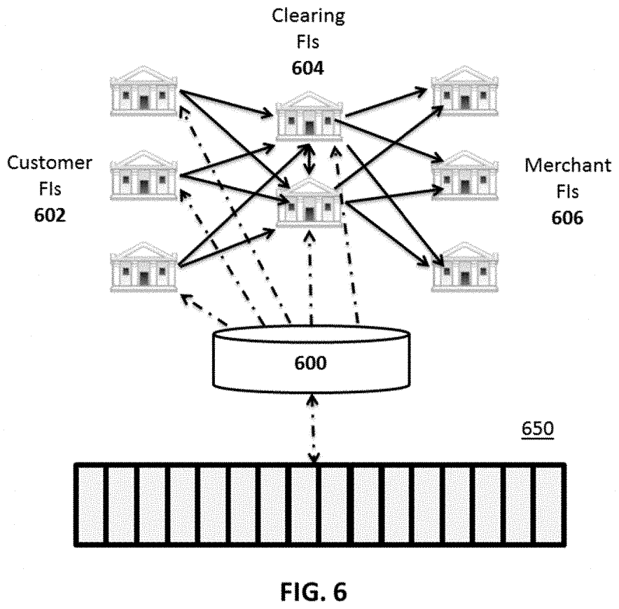

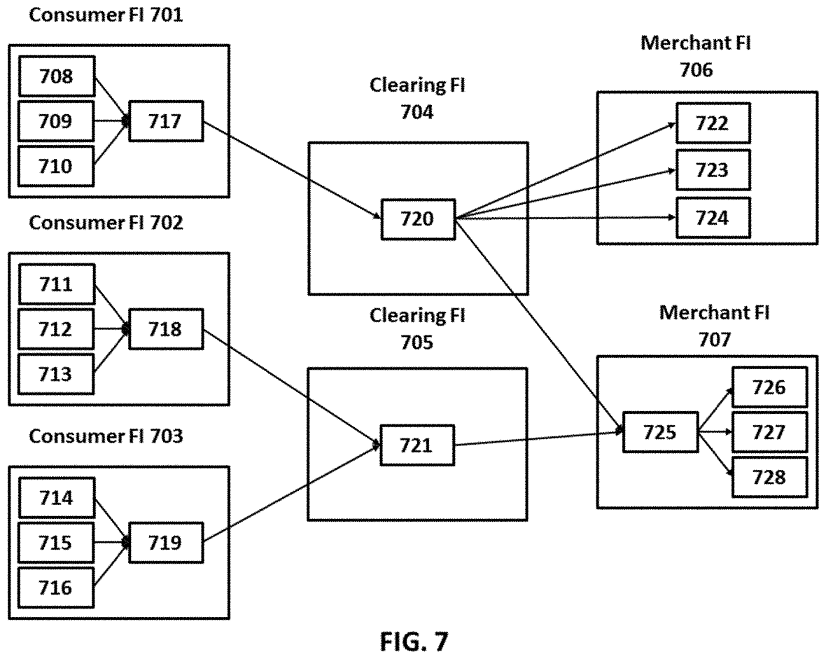

FIG. 6 illustrates transaction flows with a blockchain network and multiple clearing financial institutions. As described with respect to FIG. 2 and FIG. 5, when a fund transfer is initiated from a first user (e.g., customer) to a second user (e.g., merchant), a fund transfer system 600 may facilitate such fund transfer with both transfers of both digital tokens in a blockchain network 650 and transfer of fiat currency intra-FI or inter-FIs, such as between customer FIs 602, clearing FIs 604, and merchant FIs 606. The benefits of having multiple intermediary clearing accounts at multiple intermediary clearing financial institutions are described in further detail in FIG. 7.

FIG. 7 shows a schematic transfer flow with multiple intermediary clearing accounts at multiple intermediary clearing financial institutions. One or more customers may be accountholders at a customer FI (e.g., 701, 702, and 703), and one or more merchants may be accountholders at a merchant FI (e.g., 706, 707). Funds may be transferred from a customer account (e.g., one of customer accounts 708-716) to a merchant account (e.g., one of merchant accounts 722-724, 726-728), such as by passing through an intermediary customer FI holding account (e.g., one of 717-719), then through one or more intermediary clearing accounts 720, 721 at a clearing FI (e.g., 704, 705), and then through an intermediary merchant FI holding account 725. The one or more customer FIs, one or more clearing FIs, and one or more merchant FIs may each be the same FI or different FIs, or some FIs may be the same FI and other FIs may be different FIs. In some instances, the funds may be transferred directly from a customer account to a merchant account without passing through one or more intermediary clearing account and/or without passing through one or more intermediary holding accounts.

A transfer can be initiated by the customer, such as by submitting a request to ‘push’ funds to a merchant, such as from a customer account 708 to a merchant account 726. Alternatively, a transfer can be initiated by the merchant, such as by submitting a request to ‘pull’ funds (e.g., automatic bill payment, etc.) from a customer. Such requests, commands, and/or instructions can be made electronically and/or online. Both the customer FI 701 to which the customer account 708 belongs and the merchant FI 707 to which the merchant account 726 belongs can be “in-network” FIs (e.g., for which an intermediary has an intermediary holding account).

Upon initiation of the transfer, the fund transfer system (e.g., system 100 in FIG. 1) can first initiate a transfer from the customer account 708 to an intermediary customer FI holding account 717. The customer account and the intermediary customer FI holding account can both be at the same customer FI 701. An “on us” transfer may be completed between the customer account and the intermediary customer FI holding account. Such “on us” transfers may incur relatively little or no cost and be completed in relatively less time. Such “on us” transfers may be completed instantaneously or substantially instantaneously.

The fund transfer system can then initiate a transfer from the intermediary customer FI holding account 717 to an intermediary clearing account. There can be a first intermediary clearing account 720 at a first clearing FI 704 and a second intermediary clearing account 721 at a second clearing FI 705 from which funds can be transferred to the merchant FI 707. The fund transfer system may select to transfer the funds to the first clearing FI 704 based on one or more factors (e.g., buffer funds available, time delay, costs, etc.) that are described further below. For example, based on these factors, the fund transfer system can initiate a transfer from the intermediary customer FI holding account 717 to the first intermediary clearing account 720. An ACH process may be used for this transfer. Alternatively, an “on us” transfer may be completed, for example, if the customer FI 701 and the first clearing FI 704 are the same FI.

The fund transfer system can then initiate a transfer from the first intermediary clearing account 720 to an intermediary merchant FI holding account 725. An ACH process may be used. Alternatively, an “on us” transfer may be completed, for example, if the first clearing FI 704 and the merchant FI 707 are the same FI. The fund transfer system can then initiate a transfer from the intermediary merchant FI holding account 725 to the merchant account 726. An “on us” transfer may be completed between the intermediary merchant FI holding account and the merchant account. Such “on us” transfers may incur relatively little or no cost and be completed in relatively less time.

Similarly, upon request for other transfers from accounts at a transferor FI (e.g., 701, 702, 703) to a transferee FI (e.g., 706, 707), such as requests to transfer from customer accounts 708-716 to merchant accounts 722-724, 726-728, the fund transfer system can direct the transfers first through an intermediary customer FI holding account 717-719, then to an intermediary clearing account 720, 721 which is selected based on one or more factors, and then to an intermediary merchant FI holding account 725. If either the transferor FI or the transferee FI is an “out of network” FI, funds can be transferred without passing through an intermediary holding account from an intermediary clearing account to the “out of network” FI.

The fund transfer system can determine which clearing FI and/or which clearing account to use as a function of factors such as FI operating hours or status, FI relationships, intermediary status at FI, FI reputation and capability, fund transfer amount, available buffer at a clearing account, transactional cost, transactional cost basis, total transfer time, and other relevant factors.

Transfer can depend on government regulations, FI operating hours or status. For example, transfer to or from a clearing account at a clearing FI may not be available if services are down at a particular time at the clearing FI (e.g., due to observation of holidays, technical outage, system blackout, maintenance hours, etc.) during an anticipated transfer time, or a government regulation may restrict the volume of transfers an FI can make in a given period of time. The system may thus initiate transfer to a different clearing FI. Transfer can depend on intermediary status at a FI. For example, a FI may charge different costs and/or offer different delivery (e.g., transfer) times for clients with different status. In some instances, a FI may waive, reduce, or otherwise discount transfer or transaction costs for loyal or frequent clients, very important clients, clients having an amount of funds over a predetermined threshold (e.g., over $1,000, over $5,000, over $10,000, over $100,000, over $200,000, over $300,00, over $400,000, over $500,000, over $1,000,000, etc.) in one or more accounts at the FI, or other clients that have achieved special status. If the intermediary has achieved a special status or a special relationship (e.g., business terms) with a FI, the transfer cost can be waived, reduced, or otherwise discounted and make selection of the FI more favorable.

Transfer can depend on relationships between different FIs. For example, different FIs may have different preferred clearing FIs. In some instances, a plurality of FIs may be part of a same consortium, wherein in a clearing FI is selected from the consortium. In some instances, a clearing FI may provide or offer different (e.g., better, more timely, lower cost, etc.) services to certain FIs that have a special (e.g., business, municipal, etc.) relationship to the clearing FI.

Transfer can depend on the reputation of the FI. For example, a FI with higher reputation (e.g., with little or no record of complaints) or having certain guarantees (e.g., account balance protection policies) can be more favorable for selection than an FI with lower reputation or having no or little guarantees in the event of bankruptcy or occurrence of other unpredictable events. Customer service reputation of FI can also be a factor. Transfer can also depend on the capabilities of an FI to process a transfer. For example, a FI may or may not be able to facilitate certain international transfers to specific countries. A FI may or may not be able to process transfers in certain currencies. In some instances, a FI may not be able to facilitate certain international transfers and/or transfers in certain currencies effectively. A FI can be selected for its capabilities to facilitate a certain type of transfer.

Transfer can depend on fund transfer amount and available buffer funds at a clearing account. For example, if the transfer amount is low, a FI assessing costs at per amount basis can be more favorable. If the transfer amount is high, a FI assessing costs at per amount basis can be unfavorable. For example, if the fund transfer amount is high, and the system is likely to initiate a transfer simultaneously to and from a clearing account, the clearing account selected must have sufficient funds to at least cover the fund transfer amount.

Transfer can depend on transaction cost and transaction cost basis. For example, some FIs may assess transaction cost on a per transaction basis, per client basis, per amount basis. Clearing FIs and/or clearing accounts can be selected based on anticipated total transaction cost for transfer to and from the clearing FIs and/or clearing accounts.

Transfer can depend on total transfer time. For example, some FIs may offer different transfer or delivery time options. Accelerated delivery time options may incur extra costs. Such extra costs can also be considered by the fund transfer system as a factor. Clearing FIs and/or clearing accounts can be selected based on anticipated total transfer time to and from the clearing FIs and/or clearing accounts.

Transfer can depend on transferor and/or transferee requests. For example, a transferor and/or transferee may make hard requests as to total transaction costs and/or total transfer time, which the system may accommodate when selecting the clearing FIs and/or clearing accounts. In some instances, the fund transfer system may select clearing FIs and/or clearing accounts to optimize total transaction costs (e.g., preferably low), total transfer time (e.g., preferably low), and security and reliability (e.g., preferably high). The systems and methods described herein may implement one or more algorithms to make such determinations and/or perform such optimizations.

While FIG. 7 shows exemplary fund transfer paths, the fund transfer paths are not limited as such. In some instances, a transfer path can include any number of intermediary clearing accounts at any number of clearing FIs, wherein the funds pass through sequentially or selectively. In some instances, a transfer path can include any number of intermediary holding accounts, wherein the funds pass through sequentially or selectively. Such intermediary clearing accounts and/or holding accounts may be managed or owned by the same or different intermediaries. In some instances, for example, the system may achieve a fund transfer path of x amount of fund from a customer account 708 to a merchant account 726 by transferring x amount of fund to the intermediary holding account 717, transferring x amount of fund from the intermediary holding account 717 to the clearing account 720, but transferring x amount of fund to the intermediary holding account 725 from a different clearing account 721, and transferring x amount of fund from the intermediary holding account 725 to the merchant account 726. Thus, the transfer path may not necessarily be connected fluidly via common accounts (e.g., holding accounts, clearing accounts, etc.).

While FIG. 7 illustrates transfers between a customer and a merchant, the parties are not limited as such. The descriptions herein can apply to a transfer between any transferor (e.g., customer, sender, payer, etc.) and any transferee (e.g., merchant, recipient, payee, etc.).). For example, the transfer can be any type of transfer described elsewhere herein (e.g., external funds transfer, person-to-person (P2P) transfer, business-to-business (B2B) transfer, online banking payment, government payment or disbursement, mortgage or bill payment, direct deposit, etc.).

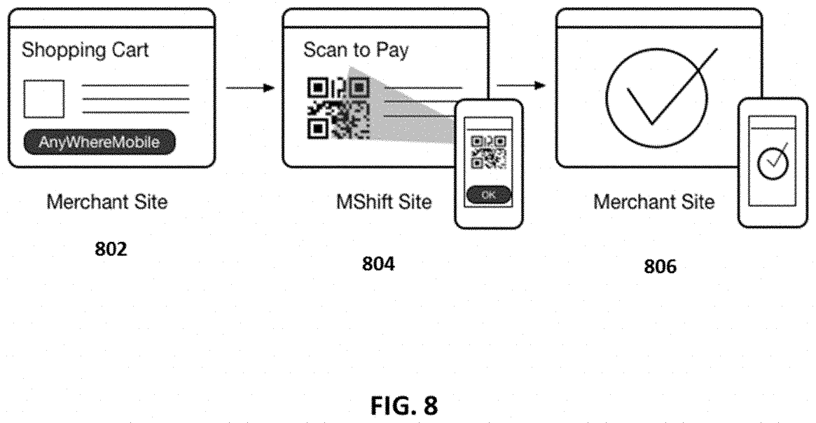

FIG. 8 illustrates an example process for initiating a fund transfer. In a first operation 802, a user (e.g., customer) may visit a vendor's website or other web-based user interface, such as via a user device of the user over a network (e.g., Internet). The vendor may optionally display compatibility for fund transfer using the fund transfer systems described herein (e.g., “AnyWhereMobile”). In some instances, the functionalities of the fund transfer systems described herein may be integrated into existing servers (on various operating systems) via an API. After selecting goods or services, the user may be directed to a check-out page on the vendor's website. In a second operation 804, during payment options, the user may be presented a graphical indicia, such as a quick response (QR) code, and scan the graphical indicia. The communications available between the user device of the user, a user device (e.g., server) of the vendor, and the server of the fund transfer system is described in further detail with respect to FIG. 3. While FIG. 3 illustrates invoice payment between a customer and a merchant, the payments are not limited as such. The descriptions herein can apply to a point of sale system in a physical retail shop or ecommerce online shopping system.

In a third operation 806, after the fund transfer system has successfully initiated fund transfer and/or confirmed fund transfer, the user may be presented with a confirmation notice.

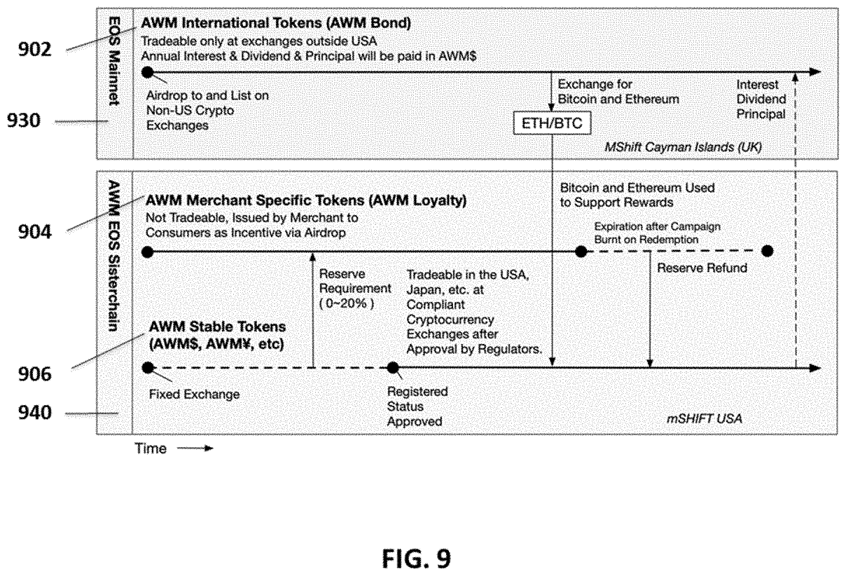

FIG. 9 illustrates a flow chart of different digital tokens. Provided are methods for digital token distribution. There are several modalities by which tokens can be distributed, including airdrops and rewards for network participants. The methods described herein may allow for flexible exchange and distribution of digital tokens with cryptocurrencies having regulatory restrictions. For example, the trade or exchange of cryptocurrency tokens may be restricted by regulatory authorities, such as the Securities and Exchange Commission (SEC), which only recognizes certain cryptocurrencies as non-securities (e.g., Bitcoin, Ethereum) and other cryptocurrencies as securities which must be registered before becoming available for trade or exchange. However, such registration procedures may be complex and time-consuming.

Provided are three types of digital tokens: a first international digital token 902 (also referred to herein as bond token), a reward digital token 904, and a cryptocurrency digital token 906, that can facilitate digital token distribution in a network while complying with the aforementioned regulatory restrictions. The international digital token 902 may only be available outside the jurisdiction of a regulatory authority (e.g., outside the United States). The cryptocurrency digital token 906 may be available for trade within the jurisdiction of the regulatory authority (e.g. ,within the United States) after having complied with regulatory restrictions, such as successfully completing an S-1 or other sanctioned registration of the tokens with the Securities and Exchange Commission. The reward digital token 904, though not available for trade at an exchange, may serve as tokens for purchases, rewards for purchases, and/or compensation for certain entities. The reward digital token 904 may be burnt upon expenditure at such entities or expired after an expiration date (e.g., of a campaign by the certain entities). The reward digital token 904 may be specific to the issuing entities.

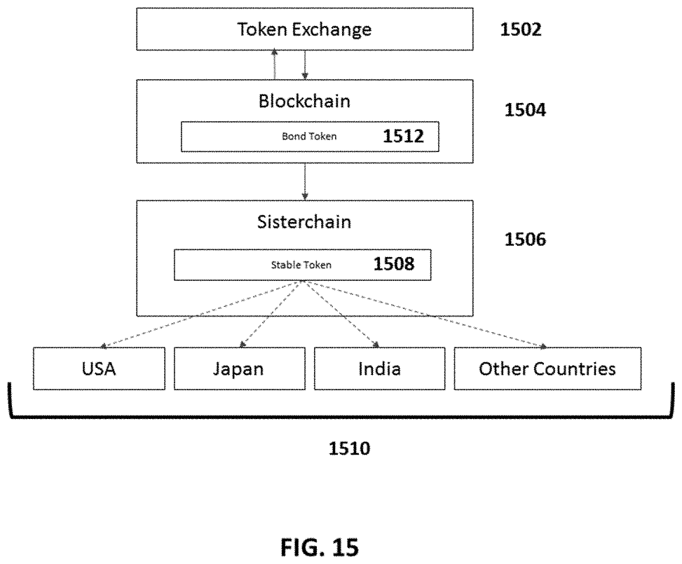

The three types of digital tokens provided herein, and the token economy defined thereby, may be maintained via a plurality of blockchain networks, such as by a dual blockchain system. The dual blockchain system may comprise a first blockchain network 930 supporting and/or hosting the international digital token 902, and a second blockchain network 940 (which may be a sisterchain to the first blockchain network 930) supporting and/or hosting both the reward digital token 904 and the cryptocurrency digital token 906. While a dual blockchain system is described, for example, it will be appreciated that any number of blockchain networks may be used. For example, a blockchain system may comprise three blockchain networks, a separate blockchain network for each digital token. The blockchain networks may be in communication via a central entity as described elsewhere herein. The plurality of the blockchain networks is described further with respect to FIG. 15.

In some instances, the international digital token 902 (or bond token) may only be available outside the jurisdiction of interest (e.g., outside the United States). In an example, these tokens 902 may be initially airdropped, that is, given on the blockchain without restrictions, to non-U.S. persons who participated in the EOS token Initial Coin Offering (ICO). Participants in the EOS ICO were required to declare that they were not U.S. citizens, so the airdrop will assure that the tokens are released to a large number of people who are not U.S. citizens, such that they will not be subject to the rules of the SEC. The international digital token 902 may then be listed on exchanges that bar trading by users restricted by the regulatory authority in the jurisdiction of interest (e.g., exchanges that bars U.S. citizens). Once the cryptocurrency digital token 906 is available for trade within the jurisdiction of interest (e.g., within the United States), the international digital token 902 may be used as a reference to establish the price of the cryptocurrency digital token 906 traded to users of the jurisdiction of interest. The international digital token 902 may also be used as a reference for the value of the reward token 904. The international digital token 902 may be used to buy (and sell) cryptocurrencies in the jurisdiction of interest that are not regulated by the regulatory authority (e.g., Bitcoin, Ethereum), and transfer these tokens to the jurisdiction of interest, such as to fund the network and fund rewards for users of the jurisdiction of interest. The token 902 may also serve to function as a bond with or without a maturity date with interest, wherein holders may have the right to request principal redemption after a certain period of time. In some instances, after an initial period, newly minted tokens 902 may be distributed to existing bondholders as dividend in proportion to their ownership percentage of the finite total number of tokens 902 in the system. Beneficially, such tokens 902 may function as both bond-like and stock-like financial instruments, providing both interest income and dividend income.

The reward digital token 904, though not available for trade at an exchange, may serve as tokens for purchases, rewards for purchases, and/or compensation for certain entities. The reward digital token 904 may be burnt upon expenditure at such entities or expired after an expiration date (e.g., of a campaign by the certain entities). The reward digital token 904 may be specific to the issuing entities. An issuing entity may create a reward digital token that is specific to the issuing entity. Such token may be redeemed solely with the issuing entity. In some instances, the reward digital token may be broadcasted and airdropped to users (e.g., potential customers to the issuing entity). The distribution may be targeted airdrops. The distribution may be in response to active queries by the users (e.g., users that broadcast a demand), or distributed as a first line of communication to the users. Such reward digital tokens may be especially beneficial for tracking user response to distribution (e.g., to gage the success of a broadcast campaign) of the reward digital tokens as they may only be redeemed at the issuing entity. In some instances, the reward digital token may be distributed to users who are frequent customers to the issuing entity and can be used to incentivize loyalty. For example, the tokens 904 may be used both to make purchases and also to give as rewards to customers who use the blockchain (e.g., the tokens 904) for purchases. The tokens may be financed by the specific vendor, created by the vendor on a supported blockchain network, denominated in the cryptocurrency digital token 906 currency, and its use and/or redemption be limited to the vendor.

In some instances, a user may be able to use two or more types of digital tokens to complete a single transaction. For example, a first user may use tokens 904 and token 906 to pay a total amount to a second user that issues the reward tokens 904. Upon initiating a transaction, a transfer of the two types of digital tokens may be initiated from digital accounts of the first user to digital accounts of the central entity (described elsewhere herein) on the blockchain, respectively. The reward tokens 904 may be burnt. Substantially simultaneously, a transfer of an amount of the digital token 906 from a financial institution account of the central entity to a financial institution account of the second user can be initiated. The amounts of the reward tokens 904 burnt and the digital token 906 transferred may sum to the total amount (or equivalent thereof). If both users are verified by the authoritative entit(ies) which provide digital token accounts (e.g., wallets) to the users, the second user may receive digital tokens, such as by direct or indirect transfer, in the blockchain network, from the first user's digital account to the second user's digital account, without passing through the central entity.

The cryptocurrency digital token 906 may be obtained via different methods as described elsewhere herein. For example, a user may exchange fiat currency at one or more financial institutions to obtain the token 906. Alternatively or in addition, a user may be rewarded a reimbursement, incentive, or reward amount in the token 906, as described elsewhere herein, for completing a transaction. Alternatively or in addition, a user may be rewarded an interest, dividend, or principal payments for holding the international digital token 902 in the token 906. Alternatively or in addition, a user may be rewarded for holding the cryptocurrency digital token 906 and/or the reward digital token 904 in the token 906. In some instances, a user may be awarded an interest for holding the cryptocurrency digital token 906. In some instances, the cryptocurrency digital token 906 may be collaterized with a local fiat currency for an initial time period, after which, the collaterization may be steadily decoupled. In non-limiting examples, an interest rate for holding the cryptocurrency digital token 906 may be between about 0% to about 20%, or any other rate. In non-limiting examples, an interest rate for holding the international digital token 902 may be between about 0% to about 20%, or any other rate.

FIG. 15 illustrates a dual blockchain token economy structure. In some instances, a first blockchain 1504 may support the international digital token 1512 (e.g., 902), and a sister blockchain 1506 may support the cryptocurrency digital token 1508 (e.g., 906). As described elsewhere herein, the international digital token 902 may be in communication with an exchange 1502. As described elsewhere herein, the cryptocurrency digital token 1508 may be collaterized with one or more local fiat currencies in one or more local jurisdictions 1510. Between the dual blockchain structure, a user holding the international digital token 1512 may receive interest in the cryptocurrency digital token 1508 from holding the international digital token 1512. In some instances, the sister blockchain 1506 may host or be in communication with a native or independent identity verification platform, which requires a bondholder to register and/or verify the bondholder's identity (e.g., with a verifying entity) before the interest can be received in the cryptocurrency digital token 1508.

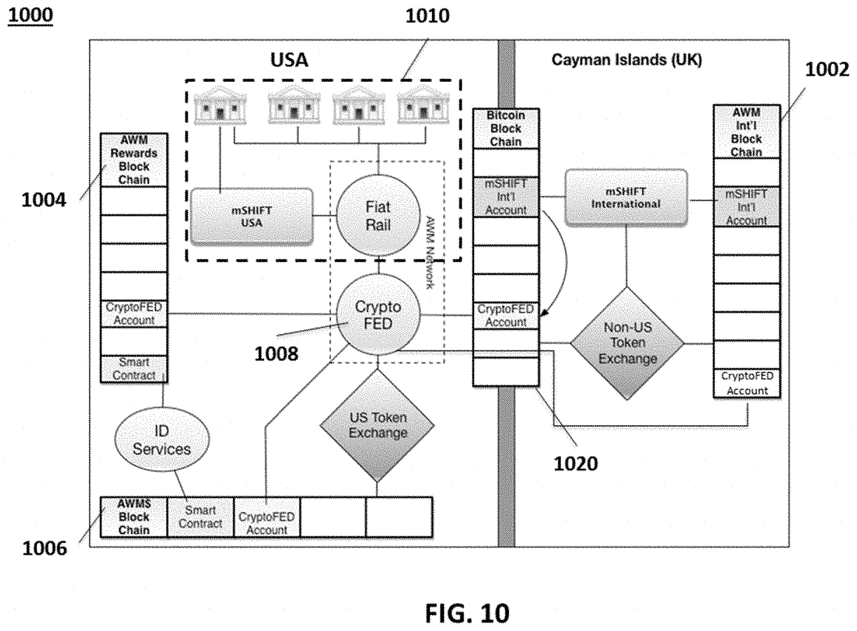

FIG. 10 illustrates a network architecture of a plurality of digital tokens. An international network architecture 1000 comprises a network of four digital tokens, including an international digital token 1002, a reward digital token 1004, a cryptocurrency digital token 1006, and a bridge digital token 1020. In some instances, the international digital token 1002 may correspond to international digital token 902, the reward digital token 1004 may correspond to reward digital token 904, and the cryptocurrency digital token 1006 may correspond to the cryptocurrency digital token 906. The bridge digital token 1020 may be a cryptocurrency unregulated by a regulatory authority (e.g., SEC) in the jurisdiction of interest (e.g., U.S.), such as Bitcoin or Ethereum. A central entity 1008 may correspond to the entities (e.g., 200, 500) described elsewhere herein. The central entity 1008 may manage, monitor, and regulate the digital tokens (e.g., 1002, 1004, 1006) by maintaining a digital account for each of the domestic digital tokens 1004 and 1006 directly and managing a digital account for international digital token 1002 indirectly via the bridge digital token 1020. The central entity 1008 may further manage fiat balance and transactions via fiat network 1010, which inter-FI and intra-FI processes are described in further detail elsewhere herein.

The various transaction cost saving methods described herein may be leveraged to facilitate a growing economy by factoring in inflation to the digital token architectures, and money injection supplies, described herein. A central entity (e.g., 206, etc.) described herein may be authorized to maintain or adjust a target inflation rate. As non-limiting examples, the inflation rate that is factored in can be maintained between about 2% to about 6%, such as based on the monetary supply mechanisms adopted by several currently existing central banks or their equivalents (e.g., U.S., Europe, Japan, India, etc.). Implementing the inflation rate may facilitate growth of the token economy by supplying sufficient monetary supply, preempting deflation, and allowing for flexible control by central entities (e.g., central entity 1008) which can, for example, raise interest rates to control inflation rate. In some instances, the exchange rate between the cryptocurrency digital token and other major fiats may be considered when selecting an inflation rate. The term “token economy,” as used herein, may refer to the micro- and macro-economics of a digital token (e.g., cryptocurrency digital token) and/or its affiliated digital tokens.

In some instances, the inflation rate in the token economy described herein may be measured by examining the weighted average of cryptocurrency digital token prices of a basket of consumer goods and services, such as transportation, food and medical care (e.g., by taking price changes for each item in the predetermined basket of goods and averaging them). In some instances, a custom survey of Consumer Price Index (CPI) may be generated. For example, the survey may be automated via the blockchain networks described herein, such as by requesting one or more groups of users (e.g., including vendor users) to provide pricing input regularly to the central entity. Once the token economy reaches a sustainability phase, the cryptocurrency digital currency minted each year to maintain the inflation target may be used to pay the bond token holder's principal, interest, and dividend, and other administration costs and expenses (e.g., rewards, reimbursements, etc.), thus making the token economy self-sustainable. Alternatively or in addition to maintaining inflation rate, the central entity described herein may otherwise function as a central financial institution (e.g., central bank) to implement and enforce one or more monetary policies. The central financial institution may be authorized to buy and sell cryptocurrency digital tokens via exchanges. The central financial institution may be authorized to buy and sell international digital tokens via exchanges. The central financial institution may be authorized to adjust a reward token reserve within a certain range (e.g., 0-20%). For example, the reserve may be maintained by specific vendors (of loyalty tokens) posting a stake and contributing to the reserve, which may be returned to the vendors at the end of a campaign.

The token economy described herein may accrue or reach a critical mass within a certain period of time after formation. Critical mass may generally refer to the number of daily active users a network requires to witness exponential growth for a noticeable duration of time (not necessarily forever)—where the number of daily active users has no likelihood of returning to 0. Exponential growth may be used to describe a larger than linear growth. The size of the critical mass may depend on an ‘instability’ factor of the network. A system may be characterized as mathematically unstable if small perturbations or deviances result in a relatively massive acceleration away from the equilibrium (equilibrium=number of daily active users in the early stages of the network˜0). The Fisher Equation (MV=PT) may be referenced to monitor or facilitate growth of the economy to achieve the critical mass, where M=money supply of the token, V=velocity of token circulation, P=average price level of token, and T=numbers of transactions. Comparing M₁V₁=P₁T₁ for a first time point and M₂V₂=P₂T₂ for a second time point, we can obtain the following relationship: (M₂/M₁)=(P₂/P₁)(T₂/T₁), where V₂=V₁ is assumed because money velocity is relatively constant in a developed economy. (M₂/M₁) may be correlated to the money supply injection rate, (P₂/P₁) may be correlated to the inflation rate, and (T₂/T₁) may be correlated to the growth rate in transaction count. If, for example, an annual inflation rate is fixed to 4%, the following relationship is obtained: (M₂/M₁)=1.04 (T₂/T₁). Methods of the present disclosure may comprise determining a transaction growth rate, and based on such transaction growth rate, determining a money injection rate to obtain a fixed inflation rate (e.g., 4%, 6%, etc.).

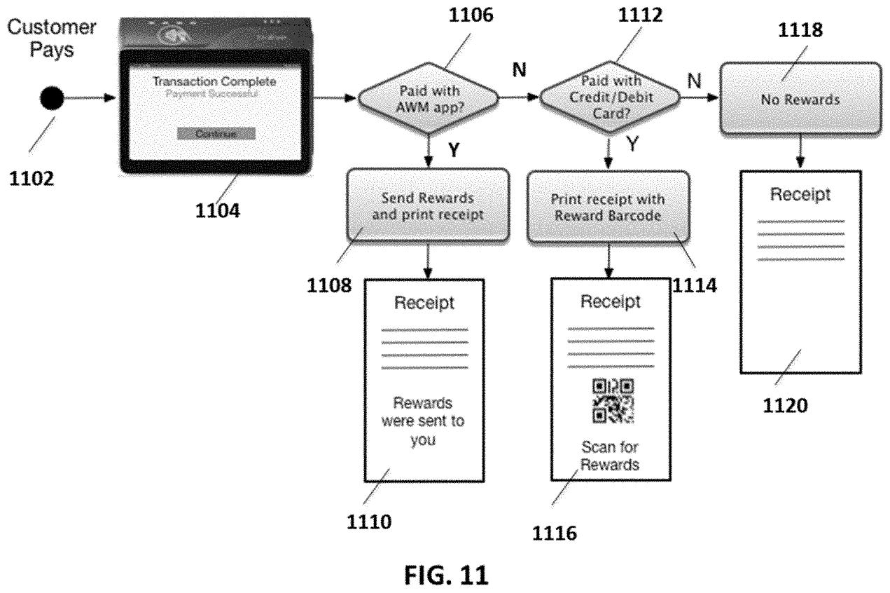

FIG. 11 illustrates an example of a process flow for rewarding a user with digital tokens along with a receipt. In some instances, when a customer completes payment of a fund 1102, and the transaction is confirmed 1104, if the customer has paid 1106 with a native application of the fund transfer system, the user may directly and/or automatically receive 1108 rewards in the digital account of the user along with a receipt 1110 confirming payment and receipt of rewards. Alternatively, if the user has not used a native application and has instead paid 1112 using a credit or debit card, the user may be provide with a receipt 1116 and a reward barcode 1114. For example, the reward barcode 1114 may be printed or otherwise provided on the receipt 1116. The user may scan the reward barcode 1114 using a native application at a later time to claim the reward, upon which the fund transfer system may transfer the rewards into the digital account of the user. If the user has neither used a native application nor paid with a credit or debit card (e.g., the user paid by mailing a cash or check), the user may not receive any rewards 1118 and be provided with a receipt 1120 detailing the payment transaction without any rewards. The user may be incentivized to use either native application or a card to complete payment to receive the rewards.

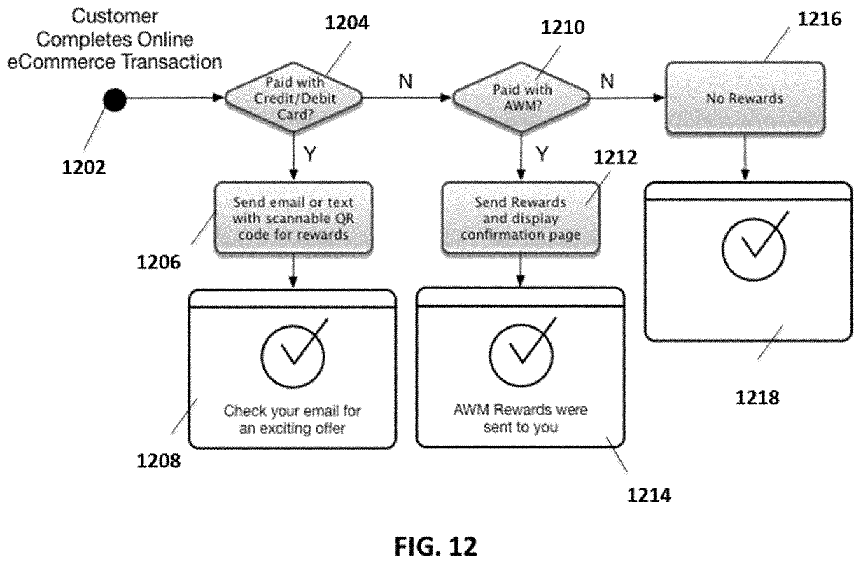

FIG. 12 illustrates an example of a process flow for rewarding a user with digital tokens for an electronic commerce payment. In some instances, when a customer completes payment of a fund 1202, and the transaction is confirmed, if the customer has paid 1204 using a credit or debit card, the fund transfer system may send 1206 a notification (e.g., via email, text, etc.) with a scannable graphical indicia (e.g., QR code) and/or a hyperlink to a rewards web site, and the user may receive a message 1208 to look out for the system notification in such email, text, or other route. The user may scan the graphical indicia (e.g., from such email, text, etc.) or click the hyperlink to claim the reward, upon which the fund transfer system may transfer the rewards into the digital account of the user. Alternatively, if the customer has instead paid 1210 using a native application of the fund transfer system, the user may directly and/or automatically receive 1212 rewards in the digital account of the user along with a message 1214 confirming the rewards. Alternatively, if the user has neither used a native application nor paid with a credit or debit card (e.g., the user paid by mailing a cash or check), the user may not receive any rewards 1216 and be provided with a message 1218 detailing the payment transaction without any rewards. The user may be incentivized to use either native application or a card to complete payment to receive the rewards.

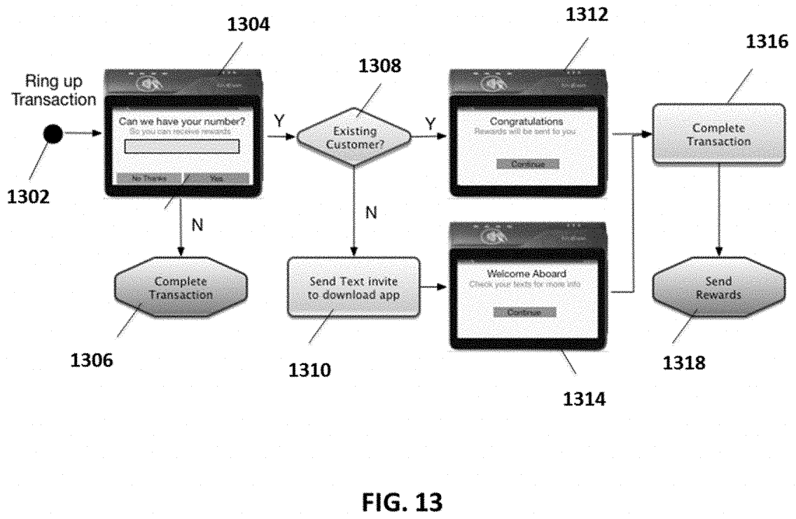

FIG. 13 illustrates another example of a process flow for rewarding a user with digital tokens. In some instances, after a customer is presented with a transaction request 1302, the system may request 1304 that the customer identify himself or herself with the fund transfer system and/or provide customer information, such as to accrue rewards. For example, the customer may identify himself or herself by providing an identification number, ID, phone number, username, or other unique identifier. If the customer refuses, the transaction can complete 1306 without any rewards. If the customer does provide information (e.g., phone number), the system may determine 1308 whether the customer is an existing (e.g., pre-registered) user, such as by comparing the customer-provided information to user information stored by the system (e.g., in a database). If the customer is an existing user, the system may present 1312 a confirmation message that rewards have been sent, the transaction can complete 1316, and the system may transfer 1318 the rewards into the digital account of the user. Alternatively, if the customer is not an existing user, the system may prompt 1310 that the customer register, such as by downloading a native application of the fund transfer system. Once the customer has registered, the system may present 1314 a confirmation message that the user has registered (and/or that rewards have been sent), the transaction can complete 1316, and the system may transfer 1318 the rewards into the digital account of the new user.

The systems and methods described herein allow consumers to be awarded with cryptocurrency rewards by the blockchain network. In some instances, individual merchants may further implement their own rewards systems, such as to reward customers for transactions with the respective individual merchants. Beneficially, this may incentivize high frequency transactions and customer loyalty to the respective individual merchants.

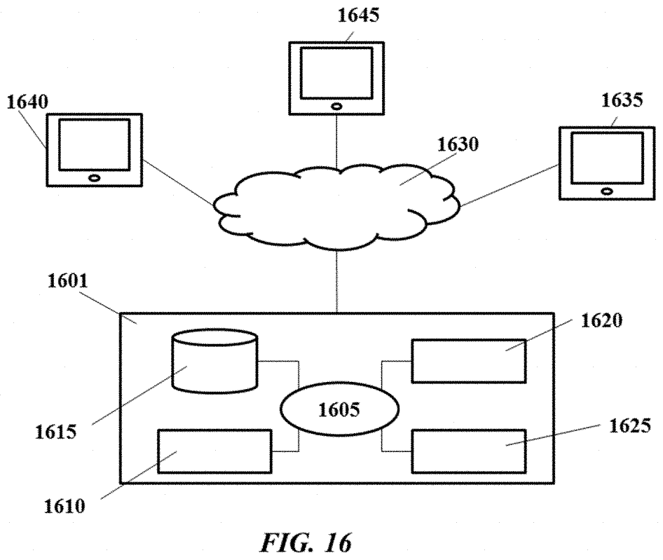

FIG. 16 shows a computer system 1601 that is programmed or otherwise configured to implement systems and methods of the present disclosure, such as to facilitate transfer of funds, payment processing, blockchain management, and other systems and methods. In some instances, the fund transfer system 100 in FIG. 1 can comprise the computer system 1601.

The computer system 1601 includes a central processing unit (CPU, also “processor” and “computer processor” herein) 1605, which can be a single core or multi core processor, or a plurality of processors for parallel processing. The computer system 1601 also includes memory or memory location 1610 (e.g., random-access memory, read-only memory, flash memory), electronic storage unit 1615 (e.g., hard disk), communication interface 1620 (e.g., network adapter) for communicating with one or more other systems, and peripheral devices 1625, such as cache, other memory, data storage and/or electronic display adapters. The memory 1610, storage unit 1615, interface 1620 and peripheral devices 1625 are in communication with the CPU 1605 through a communication bus (solid lines), such as a motherboard. The storage unit 1615 can be a data storage unit (or data repository) for storing data. The computer system 1601 can be operatively coupled to a computer network (“network”) 1630 with the aid of the communication interface 1620. The network 1630 can be the Internet, an internet and/or extranet, or an intranet and/or extranet that is in communication with the Internet. The network 1630 in some cases is a telecommunication and/or data network. The network 1630 can include one or more computer servers, which can enable distributed computing, such as cloud computing. The network 1630, in some cases with the aid of the computer system 1601, can implement a peer-to-peer network, which may enable devices coupled to the computer system 1601 to behave as a client or a server.

The CPU 1605 can execute a sequence of machine-readable instructions, which can be embodied in a program or software. The instructions may be stored in a memory location, such as the memory 1610. The instructions can be directed to the CPU 1605, which can subsequently program or otherwise configure the CPU 1605 to implement methods of the present disclosure. Examples of operations performed by the CPU 1605 can include fetch, decode, execute, and writeback.

The CPU 1605 can be part of a circuit, such as an integrated circuit. One or more other components of the system 1601 can be included in the circuit. In some cases, the circuit is an application specific integrated circuit (ASIC).

The storage unit 1615 can store files, such as drivers, libraries and saved programs. The storage unit 1615 can store user data, e.g., user preferences and user programs. The computer system 1601 in some cases can include one or more additional data storage units that are external to the computer system 1601, such as located on a remote server that is in communication with the computer system 1601 through an intranet or the Internet.

The computer system 1601 can communicate with one or more remote computer systems through the network 1630. For instance, the computer system 1601 can communicate with a remote computer system of a user (e.g., user device having a user interface). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1601 via the network 1630. For example, the computer system 1601 can communicate with a first user device 1635, a second user device 1640, and a third user device 1645.

Methods as described herein can be implemented by way of machine (e.g., computer processor) executable code stored on an electronic storage location of the computer system 1601, such as, for example, on the memory 1610 or electronic storage unit 1615. The machine executable or machine readable code can be provided in the form of software. During use, the code can be executed by the processor 1605. In some cases, the code can be retrieved from the storage unit 1615 and stored on the memory 1610 for ready access by the processor 1605. In some situations, the electronic storage unit 1615 can be precluded, and machine-executable instructions are stored on memory 1610.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1601 can include or be in communication with an electronic display that comprises a user interface (UI) for providing, for example, QR codes, transaction information, fund transfer information, and/or other details. Examples of UI's include, without limitation, a graphical user interface (GUI) and web-based user interface. The electronic display can be integrated or in a user device (e.g., 1635, 1640, 1645). The electronic display can be external to a user device and in communication via wireless or wired connections to the user device. Methods and systems of the present disclosure can be implemented by way of one or more algorithms. An algorithm can be implemented by way of software upon execution by the central processing unit 1605.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-23. (canceled)

24. A system for a digital token economy utilizing a plurality of blockchain networks, comprising:
a first blockchain network hosting a first digital token;
a second blockchain network hosting a second digital token; and
one or more servers associated with a central entity in operative communication with the first blockchain network and the second blockchain network, wherein a plurality of registered users are registered to the one or more servers, and wherein the one or more servers are configured to transfer an amount of the second digital token to a registered user of the plurality of registered users for an activity or transaction conducted by the registered user on the first blockchain network using the first digital token.

25. The system of claim 24, wherein the activity or transaction conducted by the registered user on the first blockchain network comprises a transfer of the first digital token to a second user.

26. The system of claim 25, wherein the second digital token is usable only with the second user.

27. The system of claim 25, wherein the second digital token is issued by the second user.

28. The system of claim 24, wherein the central entity has received verification of an identity of the registered user.

29. The system of claim 24, wherein the one or more servers are configured to receive an initiation of the activity or transaction from the registered user.

30. The system of claim 29, wherein the initiation comprises use of a graphical code.

31. The system of claim 30, wherein the graphical code comprises a quick response (QR) code.

32. The system of claim 29, wherein the one or more servers are configured to provide a web-based interface for the initiation to a user device of the registered user.

33. The system of claim 29, wherein the one or more servers are configured to provide a mobile-based interface for the initiation to a user device of the registered user.

34. A method for regulating a digital token economy utilizing a plurality of blockchain networks, comprising:
(a) providing a first blockchain network hosting a first digital token;
(b) providing a second blockchain network hosting a second digital token;
(c) in response to an activity or transaction conducted by a registered user on the first blockchain network using the first digital token, transferring, by one or more servers, an amount of the second digital token to the registered user, wherein the one or more servers are associated with a central entity and in operative communication with the first blockchain network and the second blockchain network, and wherein a plurality of registered users including the registered user are registered to the one or more servers.

35. The method of claim 34, wherein the activity or transaction conducted by the registered user on the first blockchain network comprises a transfer of the first digital token to a second user.

36. The method of claim 35, wherein the second digital token is usable only with the second user.

37. The method of claim 35, wherein the second digital token is issued by the second user.

38. The method of claim 34, wherein the central entity has received verification of an identity of the registered user.

39. The method of claim 34, further comprising receiving, by the one or more servers, an initiation of the activity or transaction from the registered user.

40. The method of claim 39, wherein the initiation comprises use of a graphical code.

41. The method of claim 40, wherein the graphical code comprises a quick response (QR) code.

42. The method of claim 39, further comprising providing, by the one or more servers, a web-based interface for the initiation to a user device of the registered user.

43. The method of claim 39, further comprising providing, by the one or more servers, a mobile-based interface for the initiation to a user device of the registered user.
